(19) United States
(12) Patent Application Publication
(10) Pub. No.: US 2026/0368046 A1
(43) Pub. Date: Nov. 19, 2026

(54) MULTIPLE SYSTEMS ON CHIP ARRANGEMENT WITH VOTING SYSTEM

(71) Applicant: Francois Charles Piednoel, Santa Clara, CA (US)

(72) Inventor: Francois Charles Piednoel, Santa Clara, CA (US)

(21) Appl. No.: 19/679,391

(22) Filed: May 15, 2026

Related U.S. Application Data
(60) Provisional application No. 63/805,990, filed on May 15, 2025.

(51) Int. Cl. G06F 11/1492; G06F 9/38; G06F 9/48; G06F 11/14; G06F 11/30

(52) U.S. Cl. CPC G06F 11/1494; G06F 9/3851; G06F 9/4881; G06F 11/1423; G06F 11/3062

(57) ABSTRACT

A computing system includes a first system-on-chip (SoC) and a second SoC configured in a multiple Systems-on-Chip (mSoC) arrangement with voting system is disclosed. The first SoC publishes, in a first memory, state information corresponding to a set of tasks performed by a first plurality of computational components. The second SoC dynamically reads the state information from the first memory while maintaining a subset of a second plurality of computational components in a low power state. Each SoC comprises a distributed voting mechanism with mailbox subsystems located within a coordination chiplet, wherein outputs from one or more functional chiplets are submitted for majority voting and validation across redundant processing paths. Upon detecting a trigger based on the published state information, the second SoC activates the subset of computational components to perform the set of tasks. This computing system provides synchronized, fault-tolerant, consensus-based, and fail-operational execution across multiple SoCs.

### CROSS-REFERENCE TO RELATED APPLICATION

This application claims the benefit of the U.S. Provisional Patent Application No. 63/805,990 filed on May 15, 2025, the contents of which are incorporated by reference herein.

### TECHNICAL FIELD

The present disclosure relates generally to computing systems and architectures, and more particularly to systems and methods for providing fault-tolerant, fail-operational, and high-reliability operation using multiple system-on-chip (SoC) devices with distributed voting and cross-SoC monitoring mechanisms.

### BACKGROUND

Modern computing systems deployed in safety-critical and high-reliability environments often require continuous, deterministic, and fail-operational execution of complex computational tasks. Such systems include autonomous vehicles, robotics platforms, avionics systems, aerospace control systems, and other advanced electronic/electrical (E/E) systems that execute real-time perception, inference, decision-making, motion planning, and control operations. Failure or interruption of these operations can result in hazardous conditions, loss of system functionality, or unsafe operating behavior.

Conventional approaches for improving reliability typically employ hardware redundancy techniques such as duplicated processors, lockstep execution, checkpoint recovery mechanisms, or centralized safety controllers. In lockstep architectures, multiple processors execute identical instructions simultaneously and compare outputs to detect mismatches. Other systems periodically save execution states and attempt recovery after fault detection. While such approaches provide certain levels of fault detection and redundancy, they often introduce increased power consumption, reduced computational efficiency, centralized bottlenecks, and latency associated with re-computation or restart operations. Furthermore, many conventional architectures are unable to seamlessly validate and transfer execution of ongoing tasks between distributed processing domains without interruption.

Recent system-on-chip (SoC) architectures integrate heterogeneous computational components, including central processing units, machine learning accelerators, memory subsystems, sensor interfaces, and specialized compute chiplets, to improve performance and workload scalability. However, these distributed architectures introduce additional complexity and potential fault conditions at the chiplet, interconnect, memory, and power-distribution levels. Existing redundancy systems do not effectively utilize distributed chiplet architectures to provide real-time consensus validation, cross-chiplet arbitration, or coordinated failover across multiple SoCs and heterogeneous compute domains.

In many existing systems, fault management and supervisory control rely on centralized monitoring components or external safety controllers that may themselves become bottlenecks or single points of failure. Additionally, conventional systems often lack mechanisms for distributed voting, runtime workload redistribution, selective chiplet isolation, or dynamic degradation handling during execution of mission-critical tasks. As a result, failures occurring within one processing component may propagate across the system or require complete subsystem shutdown and restart.

Advanced autonomous and intelligent systems increasingly rely on machine learning-based inference engines, neural network processing, and other non-deterministic computational models to perform perception, object detection, classification, prediction, and autonomous control functions. While such systems can provide high-performance autonomous behavior, they present significant challenges for functional safety certification because output may not always be deterministic, reproducible, or formally verifiable. Existing architectures often lack mechanisms for real-time validation of inference outputs, distributed arbitration of computational results, and deterministic fault containment during execution of AI-driven workloads.

Safety standards such as ISO 26262 and RTCA DO-254 require high levels of fault detection, redundancy, fault containment, deterministic execution behavior, and fail-operational capability for certification of safety-critical automotive and aerospace systems. Conventional architecture often cannot efficiently satisfy these requirements while maintaining scalability, distributed processing, and adaptive runtime behavior. Accordingly, there exists a need for improved computing architectures capable of providing distributed voting, cross-SoC monitoring, dynamic failover, chiplet-level fault isolation, workload redistribution, and real-time validation of computational results across multiple processing domains. There is a need in the art for ongoing research and development in this field.

### SUMMARY

The disclosed subject matter relates to a computing system implementing a multiple System-on-Chip (mSoC) architecture with a distributed voting system. This system is configured to provide redundancy, distributed fault tolerance, consensus-based execution validation, fail-operational behavior, and high-reliability operation for safety-critical applications. The computing system includes a first system on a chip (SoC) comprising a first memory in which the first SoC publishes state information corresponding to a set of tasks being performed by the first SoC. The first SoC further includes a first plurality of computational components comprising various chiplets configured to perform the set of tasks.

The computing system further includes a second SoC comprising a second memory and a second plurality of computational components. The second SoC has memory access to the first memory of the first SoC to dynamically read the state information published by the first SoC. In some embodiments, the second SoC maintains a subset of the second plurality of computational components in a low-power state while monitoring execution of the set of tasks performed by the first SoC. In certain embodiments, a plurality of SoC devices comprising corresponding computational components implemented as chiplets execute workloads across redundant processing paths while participating in distributed voting and consensus determination operations.

Each SoC comprises a distributed voting mechanism with mailbox subsystems located within a coordination chiplet. Outputs, execution data, status information, intermediate computational results, or decisions generated by one or more functional chiplets may be submitted to the mailbox subsystems for majority voting and validation across redundant processing paths. The mailbox subsystems may be interconnected to form a distributed communication and arbitration fabric. The distributed communication and arbitration fabric may support cross-chiplet communication, distributed synchronization, fault detection, error reporting, workload scheduling feedback, failover signaling, and coordinated arbitration between chiplets and SoCs.

In certain implementations, the distributed voting mechanism allows real-time consensus generation and validation of computational outputs during execution of safety-critical workloads. A voting and consensus engine may collect execution results and corresponding state information from the mailbox subsystems, compare outputs generated across redundant processing paths, determine consensus results based on voting operations, and identify chiplets associated with divergent outputs.

In certain embodiments, the set of tasks comprises autonomous system tasks, including sensor data processing, perception, inference, scene understanding, object detection and classification, motion prediction of dynamic external agents, and motion planning and execution to operate an autonomous system along a trajectory. The state information published by the first SoC may include execution information, synchronization information, intermediate computational data, workload status information, statistical information corresponding to a surrounding environment of the autonomous system, and voting-related status information associated with the distributed voting mechanism. Multiple SoC pairs and distributed compute domains may be implemented. Different SoCs or chiplets may perform subsets of autonomous tasks while participating in distributed voting and cross-SoC validation operations. In some implementations, workloads executed across redundant processing paths may include autonomous workloads, perception workloads, inference workloads, scheduling workloads, or control workloads executed across homogeneous or heterogeneous chiplets.

In some embodiments, the distributed voting mechanism supports N-modular redundancy voting across multiple SoCs distributed on one or more substrates or die packages. The distributed voting mechanism may utilize mailbox subsystems distributed across corresponding chiplets to collect local execution data, intermediate computational results, and status signals from associated chiplets. The mailbox subsystems may further support inter-chiplet voting, cross-SoC voting, consensus determination, error reporting, workload redistribution, degraded execution management, simultaneous multi-threading execution, out-of-order task scheduling, and dynamic scheduling across homogeneous and heterogeneous compute elements.

In some implementations, the distributed voting mechanism allows detection, isolation, and containment of transient and permanent faults across chiplets, processing domains, and interconnects. The distributed voting mechanism may further maintain synchronized execution and fail-operational behavior. In certain embodiments, three or more SoC devices may be implemented within a same substrate or die package, each SoC device comprising a corresponding mailbox subsystem and a coordination chiplet configured to perform N-modular redundancy voting through the mailbox subsystems to isolate divergent outputs and maintain consensus across homogeneous or heterogeneous chiplets.

In certain embodiments, when the second SoC detects a trigger while reading the state information published in the first memory, the second SoC activates the subset of computational components to perform the set of tasks. Trigger conditions may include overheating, power surges, voltage or current irregularities, execution mismatches, timing inconsistencies, memory corruption, interconnect failures, or discrepancies detected through mailbox voting operations. When the second SoC activates the subset of computational components to perform the set of tasks, the first SoC may reset or reboot one or more computational components to recover from the detected fault condition. Upon rebooting or recovery, the first SoC may assume a monitoring or backup role relative to the second SoC. The first SoC may dynamically read state information corresponding to execution of the set of tasks by the second SoC. The voting and consensus engine may isolate a chiplet associated with a divergent output and redistribute one or more workloads across remaining operational processing paths to maintain execution in a degraded operational mode

In some embodiments, each SoC monitors chiplet-level voltage, current drain, and power distribution characteristics of corresponding chiplets and selectively isolates faulty chiplets using electrical fuse (eFuse) circuitry. Each chiplet may include localized functional safety (FuSa) memory configured to store local state information and diagnostic information associated with the corresponding chiplet. The computing system may support degraded execution operation in which workloads are redistributed across remaining operational chiplets while maintaining functional safety guarantees. In some implementations, the computing system supports compliance with automotive safety integrity level (ASIL) and Design Assurance Level (DAL) requirements for autonomous systems, avionics systems, robotics systems, vehicle control systems, and flight control systems. In certain implementations, the voting and consensus engine performs heterogeneous voting operations across heterogeneous chiplets and initiates fault isolation through eFuse circuitry while maintaining consensus across remaining operational processing paths.

The foregoing is not intended to be an exhaustive list of embodiments and features of the disclosed subject matter. Persons skilled in the art are capable of appreciating other embodiments and features from the following detailed description in conjunction with the drawings.

### BRIEF DESCRIPTION OF THE DRAWINGS

The disclosure herein is illustrated by way of example, and not by way of limitation, in the figures of the accompanying drawings in which like-reference numerals refer to similar elements, and in which:

FIG. 1A illustrates a block diagram of an example computing system in which the embodiments described herein can be implemented, in accordance with the disclosed examples.

FIG. 1B illustrates a block diagram of an exemplary multiple system-on-chip (mSoC) architecture with voting system, in accordance with examples described herein.

FIG. 1C is a continuation of FIG. 1B, illustrating components associated with the distributed voting and consensus operations of the mSoC architecture, in accordance with examples described herein.

FIG. 2 is a block diagram illustrating an example of a multiple Systems-on-Chip (mSoC) configuration, consistent with the principles described in this disclosure.

FIG. 3 is a block diagram illustrating another example implementation of multiple SoC, in accordance with examples described herein.

FIG. 4 is a block diagram depicting an example central chiplet within a SoC, incorporating shared memory resources for status duplication and operational shadowing between multiple SoCs, according to examples described herein.

FIGS. 5 and 6A-6C are flow charts describing methods of implementing duplicated status, shadowing, and cross-verification for multiple SoCs, according to the examples described herein.

FIG. 7 illustrates a single-substrate mSoC architecture with multiple coordination chiplets for local and distributed voting, in accordance with examples described herein.

FIG. 8 illustrates an exemplary multiple System-on-Chip (mSoC) architecture 800 implementing a distributed voting and mailbox communication system, in accordance with examples described herein.

FIG. 9 is a block diagram illustrating an exemplary voting-based fault detection and isolation architecture in multiple SoC devices, in accordance with examples described herein.

FIG. 10 is a flow diagram illustrating an exemplary mailbox-based distributed voting and fault-handling process implemented in a multiple mSoC architecture, in accordance with examples described herein.

FIG. 11 is a block diagram illustrating an exemplary N-modular redundancy architecture implementing distributed mailbox-based voting, consensus validation, and fault isolation across multiple SoC devices.

### DETAILED DESCRIPTION

The disclosed subject matter relates to a multiple System-on-Chip (mSoC) architecture with a distributed voting system configured to provide redundancy, distributed fault tolerance, consensus-based execution validation, fail-operational operation, and high-reliability execution for safety-critical applications. The mSoC architecture includes multiple system-on-chip (SoC) devices configured to execute workloads across redundant processing paths while participating in distributed voting and consensus determination operations.

In some embodiments, the architecture supports continued execution of workloads when one or more SoCs or chiplets experience a fault condition. The continued execution does not require workload restart or reconstruction of execution state information. One or more SoCs may continuously publish execution state information into corresponding memories or mailbox subsystems. One or more peer SoCs may dynamically read the published information through one or more interconnects. The peer SoCs may maintain synchronized execution state information while maintaining subsets of corresponding computational components in low-power states. Upon detection of a trigger condition, one or more backup or monitoring SoCs may activate computational components and continue execution of workloads using the synchronized execution state information. The architecture may support role-switching operations between SoCs. The architecture may further support configurations comprising any number of SoCs and chiplet-based compute domains participating in distributed voting and redundancy operations.

The disclosed mSoC architecture differs from lockstep execution arrangements because the SoCs and chiplets are not required to execute instructions synchronously at an instruction-cycle level. Instead, the architecture utilizes distributed mailbox-based voting and consensus validation across multiple SoCs and chiplets executing workloads across redundant processing paths. The distributed voting architecture enables validation of execution outputs, synchronization information, intermediate computational results, timing information, confidence values, and health information generated across multiple chiplets and SoCs. The disclosed architecture further differs from checkpointing arrangements because execution state information may be continuously published and synchronized during runtime operation. There is no interval of work between a saved snapshot and a failure that must be discarded or recomputed. The architecture further differs from conventional hot-standby systems because one or more monitoring SoCs may already maintain synchronized execution state information. The monitoring SoCs may therefore continue execution without loading a separate recovery image or reconstructing execution state information.

The workloads executed by the disclosed mSoC architecture may include autonomous workloads, inference workloads, perception workloads, scheduling workloads, control workloads, or machine learning workloads executed across homogeneous or heterogeneous chiplets. Examples include sensor data perception, multi-sensor fusion, machine learning inference for object detection and prediction, motion planning, occupancy estimation, trajectory generation, and issuance of control commands to actuators. The execution state information shared between SoCs and chiplets may include execution context information, synchronization information, workload scheduling information, queue information, intermediate computational results, timing information, confidence values, environmental statistics, machine learning model parameters, health information, and voting-related status information associated with distributed voting operations.

The SoCs of the disclosed mSoC architecture may each include a plurality of computational components implemented as chiplets. Examples of chiplets include sensor input chiplets, central chiplets, autonomous drive chiplets, machine learning accelerator chiplets, general compute chiplets, memory chiplets, and high-bandwidth memory chiplets. In some embodiments, one or more functional chiplets publish execution results and corresponding state information into distributed mailbox subsystems associated with corresponding SoCs or coordination chiplets. A voting and consensus engine may collect execution results and corresponding state information from the mailbox subsystems. The voting and consensus engine may compare outputs generated across redundant processing paths to determine consensus results associated with execution of workloads. The distributed mailbox subsystems may further support synchronization operations, arbitration operations, workload coordination, fault reporting, and distributed execution management across multiple SoCs and chiplets.

In some embodiments, the voting and consensus engine identifies a chiplet associated with a divergent output based on comparison of outputs generated across redundant processing paths. Trigger conditions may include overheating, power surges, voltage irregularities, current anomalies, timing inconsistencies, memory corruption, arithmetic errors, chiplet failures, communication failures, synchronization mismatches, voting discrepancies, or loss of response from one or more SoCs or chiplets. The voting and consensus engine may isolate the identified chiplet and redistribute one or more workloads across remaining operational processing paths to maintain execution in a degraded operational mode. In some implementations, the SoCs and chiplets are interconnected through one or more redundant interconnect paths. The SoCs and chiplets may further include electrical safety switches, eFuse circuitry, or power isolation circuitry configured to isolate faulty chiplets or SoCs in response to fault conditions or electrical anomalies.

In some embodiments, the disclosed mSoC architecture supports N-modular redundancy voting across three or more SoC devices implemented within a same substrate or die package. Each SoC device may comprise a corresponding mailbox subsystem and coordination chiplet configured to participate in distributed voting and consensus operations across homogeneous or heterogeneous chiplets. The distributed voting mechanism may support majority voting, weighted voting, confidence-based voting, or consensus determination operations across redundant processing paths. In certain implementations, the distributed voting mechanism supports isolation of divergent outputs, workload redistribution, degraded execution operation, and consensus maintenance across remaining operational processing paths while maintaining functional safety guarantees.

In certain implementations, the voting and consensus engine performs heterogeneous voting operations across heterogeneous chiplets. The voting and consensus engine may initiate fault isolation through eFuse circuitry or power isolation circuitry while maintaining consensus across remaining operational processing paths. The disclosed mSoC architecture may support compliance with Automotive Safety Integrity Level (ASIL) requirements, Design Assurance Level (DAL) requirements, or other functional safety standards associated with autonomous systems, robotics systems, industrial automation systems, avionics systems, or vehicle control systems. The distributed voting architecture therefore provides synchronized execution validation, distributed fault isolation, workload redistribution, degraded operational continuity, and fail-operational behavior across multiple SoCs and chiplet-based compute domains.

The figures and the description that follows describe specific embodiments of distributed mailbox subsystems, voting and consensus engines, N-modular redundancy architectures, coordination chiplets, heterogeneous voting operations, fault isolation mechanisms, degraded operational modes, workload redistribution operations, and synchronized execution management across multiple SoCs and chiplets. The figures and description further describe embodiments in which SoCs publish and dynamically read execution state information to support workload continuation and failover operations across distributed compute domains. The embodiments shown are illustrative. The disclosed subject matter is not limited to these embodiments and extends to combinations and modifications that fall within the scope of the claims.

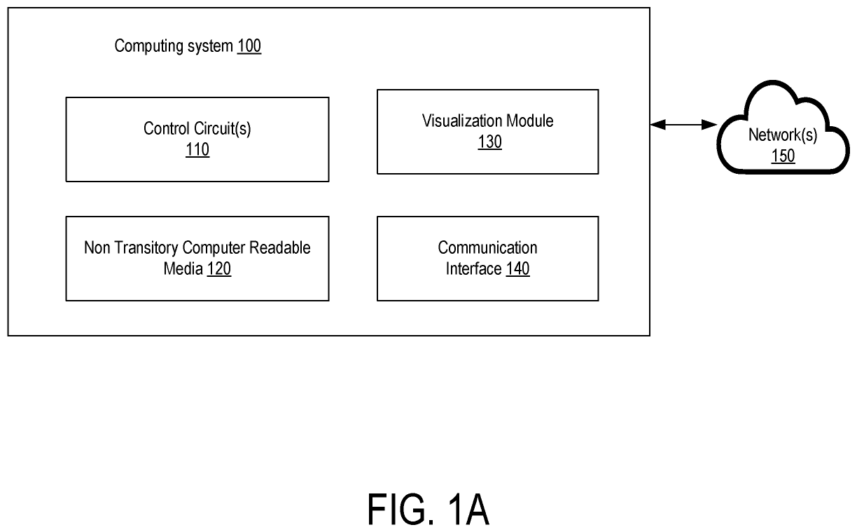

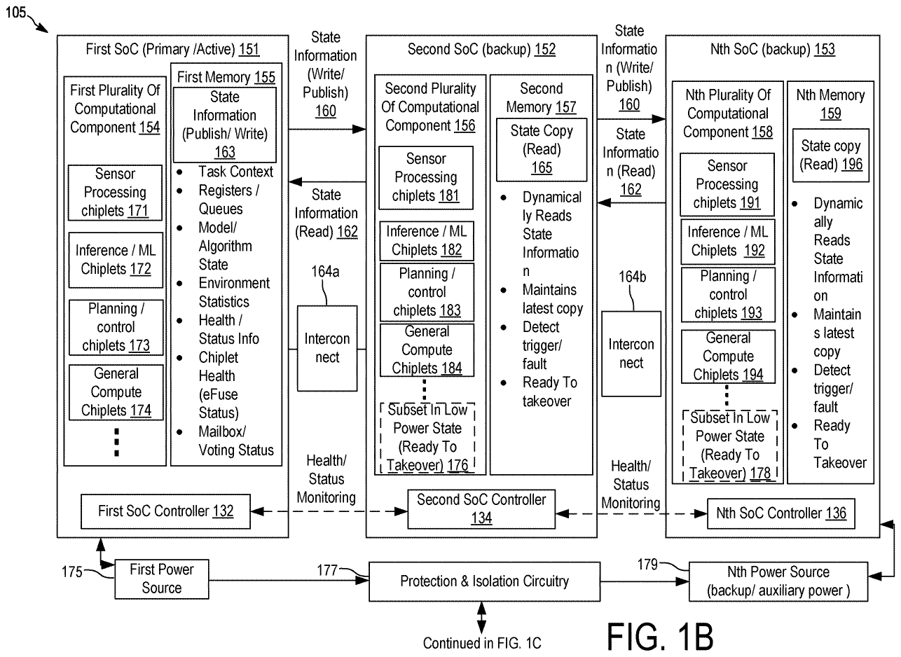

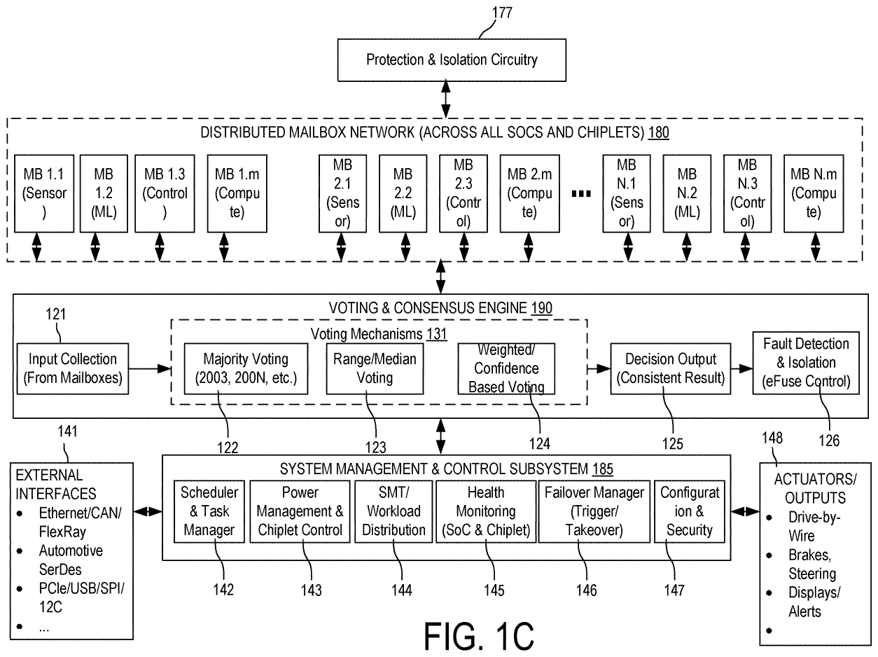

Referring to FIG. 1A, FIG. 1A is a block diagram depicting an example computing system 100 in which embodiments described herein may be implemented, in accordance with examples described herein. In an embodiment, the computing system 100 can include one or more control circuits 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), systems on chip (SoCs), or any other control circuit. In some implementations, the one or more control circuits 110 and/or computing system 100 may be part of, or may form, a vehicle control unit (also referred to as a vehicle controller) that is embedded or otherwise installed in a vehicle. For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, an autonomous vehicle control system, or any other controller (the term “or” is used herein interchangeably with “and/or”).

In addition, computing system 100 comprises a visualization module 130, which is configured to receive internal state, sensor fusion, or diagnostic output from the mSoC and render this data to human-machine interfaces, such as driver displays, maintenance consoles, or safety dashboards. The visualization module 130 may be implemented as a hardware-accelerated or software-driven rendering subsystem, and may include a redundant peer module to allow display continuity under fault conditions. In some implementations, the visualization module 130 can independently verify or cross-check critical information prior to rendering and may support ASIL-rated output paths to regulated safety displays.

In an embodiment, the one or more control circuits 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, for example, a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

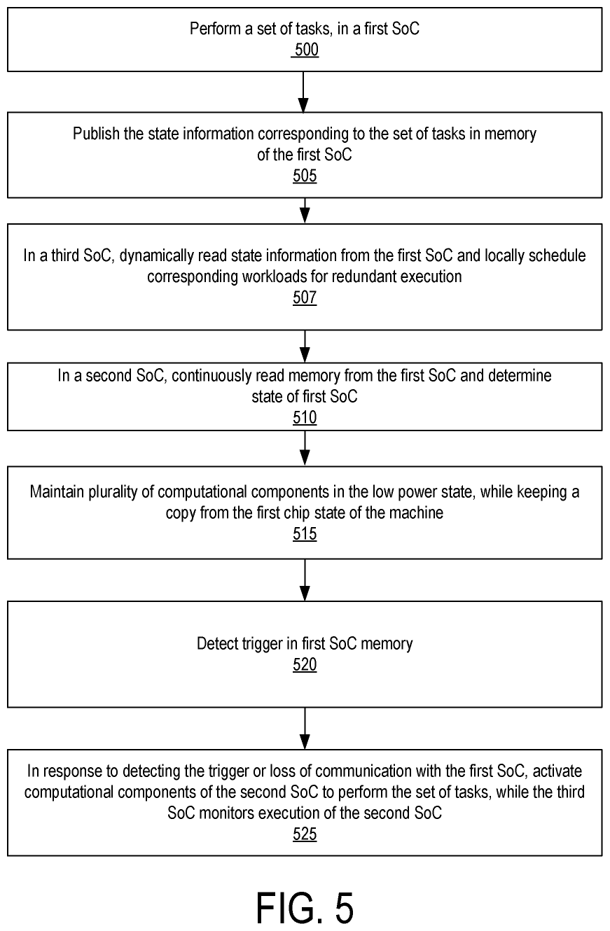

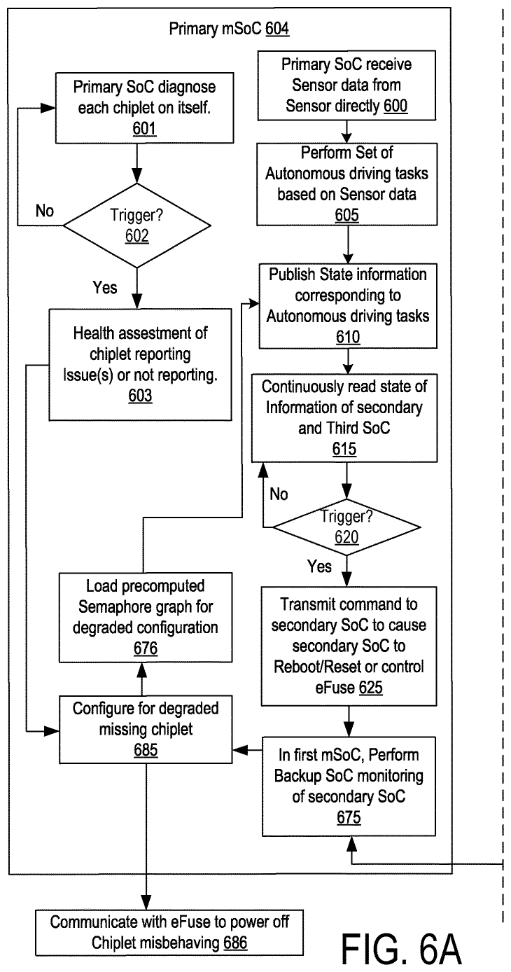

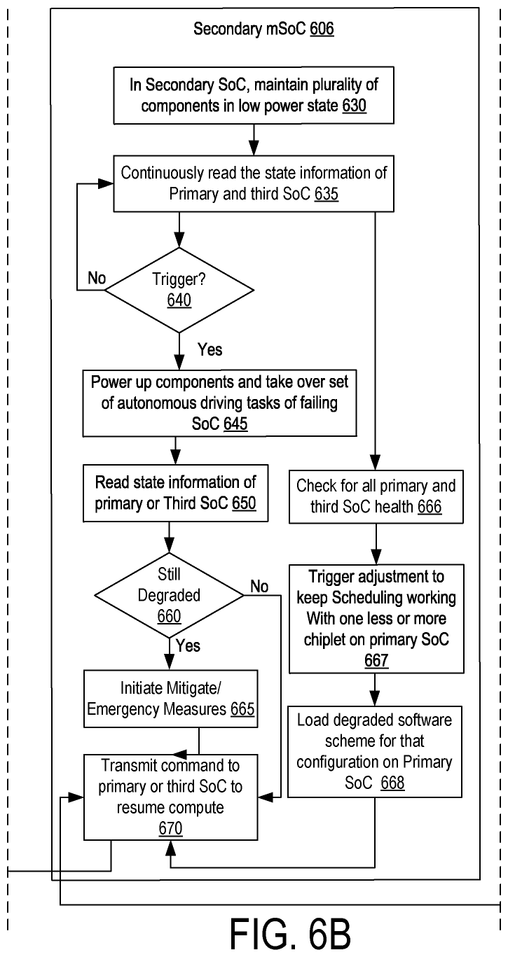

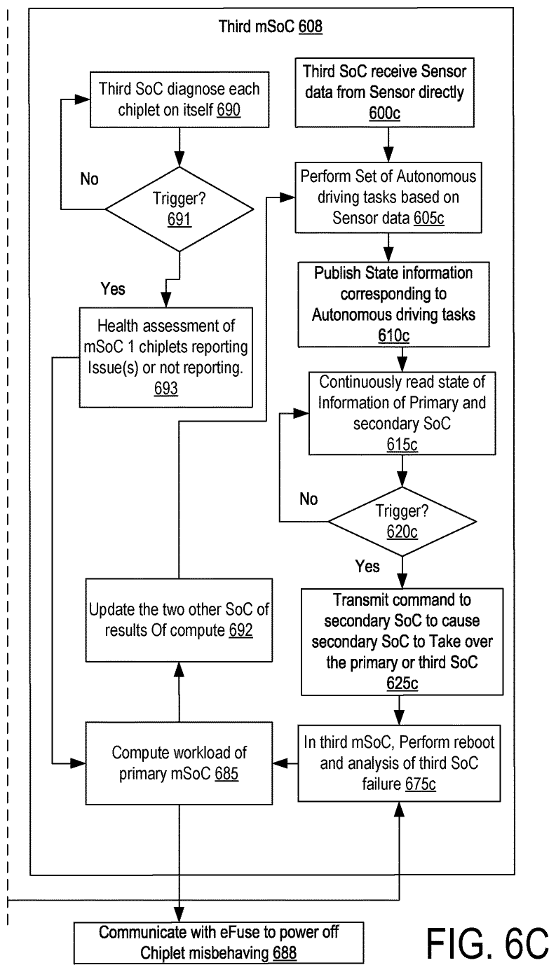

In the context of mSoC-based implementations, such memory devices may reside within shared inter-chiplet storage, chiplet-local memory, or FuSa-dedicated memory segments that hold instructions for safety-critical tasks. In some cases, the non-transitory computer-readable medium 120 may store computer-executable instructions that implement the methods described herein, including the real-time role-switching, voting logic, degraded fallback routines, and diagnostic monitoring illustrated in connection with FIGS. 5 and 6.

In various embodiments, the terms “computer-readable instructions” and “computer-executable instructions” refer to software instructions or computer code configured to carry out various operations or control logic tasks. When such instructions are grouped into modules, the term “module” refers broadly to a collection of instructions configured to cause the one or more control circuits 110 to perform one or more defined functional operations. In mSoC-based systems, these modules may reside within shared memory, individual chiplet memory, or may span multiple SoCs, and may control behaviors such as task scheduling, fault detection, voting logic, and dynamic role reassignment. The modules and instructions may be executed by the one or more control circuits 110 or other hardware components within the system, and are responsible for orchestrating both application-layer functions and low-level safety-critical mechanisms across the architecture.

In further embodiments, the computing system 100 can include a communication interface 140 that enables communications over one or more networks 150 to transmit and receive data. In various examples, the computing system 100 can communicate, over the one or more networks 150, with other systems using the communication interface 140 to receive sensor data and implement the intersection classification methods described throughout the present disclosure. In certain embodiments, the communication interface 140 may also be used to communicate with one or more external or peer systems.

The communication interface 140 may include any combination of circuits, components, or software for communicating via one or more networks 150 (e.g., a local area network, wide area network, the Internet, secure network, cellular network, mesh network, and/or peer-to-peer communication link). In some implementations, the communication interface 140 may comprise, for example, one or more communication controllers, receivers, transceivers, transmitters, ports, conductors, or supporting firmware and driver logic.

Additionally, computing system 100 may use communication interface 140 or internal buses to transmit status information, safety state, or fused sensor outputs to the visualization module 130, which is configured to render this data to displays, dashboards, or other human-machine interfaces. The visualization module 130 may support redundant output paths and operate in both normal and degraded display modes, providing visualization continuity in safety-critical environments.

In an exemplary embodiment, the control circuit 110 of the computing system 100 can include a dual SoC arrangement that facilitates the various methods and techniques described throughout the present disclosure. In various examples, the SoCs can perform a set of tasks in a primary SoC and backup SoC configuration, where the primary SoC performs the operational tasks, and the backup SoC remains in a standby or low-power state while continuously monitoring the status and/or health of the primary SoC.

In various implementations, the set of tasks may include autonomous system operations, such as perception, object detection and classification, grid occupancy estimation, sensor data fusion, motion prediction (e.g., for dynamic entities in the environment), motion planning, and trajectory control for autonomous navigation. As described herein, multiple dual-SoC pairings may be deployed, each handling a specific subset of tasks, with every pair configured according to the safety, redundancy, and failover principles detailed below.

In support of safety, diagnostics, and operator awareness, the computing system may further include the visualization module 130, capable of rendering real-time system state, task load distributions, or degraded operation indicators to one or more human-machine interfaces. In certain embodiments, the visualization module 130 may be powered independently, such that it can remain operational even when the primary and backup SoCs are rebooting, experiencing faults, or operating in degraded safety modes. This enables persistent safety-critical feedback, especially in domains such as automotive or aviation, where visual confirmation may be essential during transitions between control states.

Referring to FIG. 1B, FIG. 1B illustrates a block diagram of an exemplary multiple system-on-chip (mSoC) architecture with voting system, in accordance with examples described herein.

FIG. 1B illustrates an exemplary multiple System-on-Chip (mSoC) architecture 105 implementing distributed state sharing, cross-SoC synchronization, distributed voting operations, workload coordination, and fail-operational execution across multiple SoCs. In some embodiments, the mSoC architecture 105 includes a first SoC 151, a second SoC 152, and an Nth SoC 153 configured to communicate with one another to provide redundancy, distributed fault tolerance, consensus-based execution validation, and high-reliability operation for safety-critical applications.

In some embodiments, the first SoC 151 operates in a primary or active execution mode while the second SoC 152 and the Nth SoC 153 operate in monitoring, backup, or standby modes. The first SoC 151 includes a first plurality of computational components 154 and a first memory 155. The first plurality of computational components 154 may include one or more sensor processing chiplets 171, one or more inference or machine learning (ML) chiplets 172, one or more planning or control chiplets 173, and one or more general compute chiplets 174. The first plurality of computational components 154 may collectively execute a set of tasks associated with autonomous operation, perception, inference, planning, control, or other safety-critical computational operations.

The first memory 155 may store and publish state information 163 corresponding to execution of the set of tasks performed by the first SoC 151. In certain implementations, the state information 163 includes task context information, register data, queue information, model or algorithm state information, synchronization information, environmental statistics, workload information, health or status information, chiplet health information, electrical or eFuse status information, mailbox information, voting status information, intermediate computational results, timing information, execution checkpoints, or other runtime information associated with operation of the first SoC 151.

The second SoC 152 may include a second plurality of computational components 156 and a second memory 157. The second plurality of computational components 156 may include one or more sensor processing chiplets 181, one or more inference or ML chiplets 182, one or more planning or control chiplets 183, and one or more general compute chiplets 184. In some embodiments, the second memory 157 stores a state copy 165 corresponding to the state information 163 published by the first SoC 151. The second SoC 152 may dynamically read the state information 163 published by the first SoC 151 and continuously maintain an updated state copy 165 while monitoring the operation and execution status of the first SoC 151.

In certain embodiments, the second SoC 152 maintains a subset of computational components 176 in a low power state while remaining available to take over execution of the set of tasks upon detection of a trigger condition, fault condition, execution mismatch, timing inconsistency, synchronization failure, or voting discrepancy associated with the first SoC 151. Trigger conditions may include overheating, voltage or current irregularities, memory corruption, interconnect failures, workload imbalance, execution inconsistencies, or discrepancies detected through distributed voting operations. Upon activation, one or more computational components of the second SoC 152 may transition from the low power state to an active execution state to continue execution of the set of tasks.

The Nth SoC 153 may include an Nth plurality of computational components 158 and an Nth memory 159. The Nth plurality of computational components 158 may include one or more sensor processing chiplets 191, one or more inference or ML chiplets 192, one or more planning or control chiplets 193, and one or more general compute chiplets 194. In some embodiments, the Nth memory 159 stores a state copy 196 corresponding to the state information 163 published by the first SoC 151. Similar to the second SoC 152, the Nth SoC 153 may dynamically read the state information 163 and maintain a subset of computational components 178 in a low-power state while remaining available for failover execution, redundancy operation, distributed voting participation, or workload redistribution.

In some embodiments, the first SoC 151 publishes state information 163 through write or publish operations 160 to the second SoC 152 and the Nth SoC 153. The second SoC 152 and the Nth SoC 153 may dynamically read the state information 163 through read operations 162. Interconnects 164a and 164b may facilitate communication, synchronization, state sharing, workload coordination, mailbox communication, voting information exchange, failover signaling, and transfer of execution-related information between the SoCs. In certain implementations, the interconnects 164a and 164b comprise high-speed communication interfaces configured to support low-latency exchange of runtime information between distributed compute domains.

In certain implementations, the first SoC 151, the second SoC 152, and the Nth SoC 153 further include corresponding SoC controllers (132, 134, and 136) configured to manage execution scheduling, monitoring operations, voting coordination, synchronization operations, power management, failover operations, and communication between SoCs. The SoC controllers (132, 134, and 136) may exchange health and status monitoring information to support distributed fault detection, coordinated system recovery, runtime synchronization, and dynamic workload reassignment between SoCs.

In some embodiments, the first SoC 151 is powered by a first power source 175 and the Nth SoC 153 is powered by an Nth power source 179, which may comprise a backup power source or auxiliary power source. The SoCs may further be electrically coupled through protection and isolation circuitry 177 configured to isolate faults, protect against electrical anomalies, prevent fault propagation between SoCs, selectively disconnect faulty computational components or power domains, and support fail-safe electrical isolation during fault conditions.

The mSoC architecture of FIG. 1B may further include a distributed mailbox network 180, a voting and consensus engine 190, and a system management and control subsystem 185. For clarity of illustration, additional details associated with the distributed mailbox network 180, the voting and consensus engine 190, and the system management and control subsystem 185 are illustrated separately in FIG. 1C, which is a continuation of FIG. 1B. FIG. 1C therefore illustrates additional components and operational details associated with the distributed voting, consensus determination, failover management, workload distribution, and fault isolation operations performed within the mSoC architecture.

FIG. 1C comprises a distributed mailbox network 180 implemented across multiple SoCs and chiplets. In some embodiments, the distributed mailbox network 180 includes multiple mailbox (MB) subsystems distributed across sensor processing chiplets, inference chiplets, planning or control chiplets, general compute chiplets, and other computational domains associated with corresponding SoCs. As illustrated, mailbox subsystems may include MB 1.1 associated with sensor processing operations, MB 1.2 associated with inference operations, MB 1.3 associated with control operations, MB 1.m associated with compute operations, MB 2.1 associated with sensor operations of another SoC, MB 2.2 associated with inference operations, MB 2.3 associated with control operations, MB 2.m associated with compute operations, MB N.1 associated with sensor operations of an Nth SoC, MB N.2 associated with inference operations, MB N.3 associated with control operations, and MB N.m associated with compute operations. The mailbox subsystems may collect execution data, synchronization information, intermediate computational results, status signals, workload information, fault information, timing information, and voting-related information generated by corresponding chiplets.

In certain implementations, outputs and execution information collected from the distributed mailbox network 180 are provided to a voting and consensus engine 190. The voting and consensus engine 190 receives the input collection from mailboxes at block 121. The voting and consensus engine 190 may implement one or more voting mechanisms 131 configured to validate outputs generated across redundant processing paths. In some embodiments, the one or more voting mechanisms 131 include majority voting operations 122, range/median voting operations 123 or ranked voting, weighted/confidence-based voting operations 124, or other consensus determination operations. The voting and consensus engine 190 may generate a decision output 125 corresponding to a validated or consensus computational result for continued execution of safety-critical workloads.

In some implementations, the voting and consensus engine 190 may generate a consensus result corresponding to validated execution outputs determined through majority voting, weighted voting, confidence-based voting, temporal voting, or other arbitration mechanisms. The consensus result may be used for continued execution of workloads, actuator control, autonomous system operation, or workload scheduling decisions.

In some embodiments, the voting and consensus engine 190 compares outputs generated across redundant processing paths executing corresponding workloads on multiple chiplets or SoCs. When the voting and consensus engine 190 identifies a divergent output associated with a chiplet, processing lane, or SoC, the voting and consensus engine 190 may initiate fault isolation procedures, including workload redistribution, chiplet isolation, degraded execution operation, or activation of alternative operational processing paths. In certain implementations, workload redistribution may be performed dynamically while maintaining continued execution of safety-critical workloads.

In certain implementations, a divergent output corresponds to an execution result, intermediate computational result, timing result, synchronization result, or state information that differs from corresponding outputs generated by other redundant processing paths participating in a voting operation. The voting and consensus engine 190 may identify a chiplet associated with the divergent output and selectively isolate the chiplet from continued participation in workload execution.

In some embodiments, the voting and consensus engine 190 further supports fault detection and isolation operations 126 configured to identify transient faults, permanent faults, execution mismatches, timing inconsistencies, synchronization errors, divergent computational outputs, or hardware degradation conditions generated by one or more chiplets or SoCs. In certain implementations, the voting and consensus engine 190 coordinates workload redistribution, degraded execution operation, failover activation, computational component isolation, power-state management, or dynamic reassignment of workloads in response to detected discrepancies or voting failures.

In certain implementations, the computing system supports degraded operational modes in which workloads associated with isolated or non-functional chiplets are redistributed across remaining operational processing paths. During degraded operational operation, the voting and consensus engine 190 and the scheduler and task manager 142 may dynamically reassign workloads while maintaining synchronized execution, consensus validation, and functional safety guarantees. The scheduler and task manager 142 may dynamically redistribute workloads across remaining operational processing paths after isolation of a faulty chiplet, SoC, or computational domain. The redistribution may occur without requiring system restart or complete workload recomputation.

FIG. 1C further illustrates a system management and control subsystem 185 coupled to the voting and consensus engine 190. The system management and control subsystem 185 comprises a scheduler and task manager 142, power management and chiplet control circuitry 143, simultaneous multi-threading (SMT) and workload distribution circuitry 144, health monitoring and control circuitry 145, failover management circuitry 146, and configuration and security circuitry 147. In some embodiments, the scheduler and task manager 142 dynamically assigns tasks across chiplets and SoCs based on execution requirements, workload availability, fault conditions, or voting outcomes. The power management and chiplet control circuitry 143 may control activation, deactivation, isolation, or low-power operation of computational components. The SMT and workload distribution circuitry 144 may support simultaneous execution of multiple workloads across distributed compute elements. The health monitoring and control circuitry 145 may monitor operational status, timing behavior, synchronization status, and diagnostic information associated with computational components and SoCs. The failover management circuitry 146 may coordinate activation of backup SoCs, workload reassignment, degraded execution operation, or recovery procedures during fault conditions. The configuration and security circuitry 147 may manage security policies, configuration settings, access control, and integrity validation associated with operation of the mSoC architecture 105.

In some embodiments, the mSoC architecture 105 interfaces with one or more external interfaces 141 including Ethernet interfaces, automotive interfaces, peripheral component interconnect express (PCIe) interfaces, avionics interfaces, sensor interfaces, or other communication interfaces. The mSoC architecture 105 may further communicate with one or more actuator output systems 148 including drive-by-wire systems, steering systems, braking systems, display systems, robotics systems, autonomous control systems, or flight control systems.

In certain embodiments, the distributed mailbox network 180 and the voting and consensus engine 190 collectively enable real-time validation, synchronization, arbitration, and consensus generation across multiple SoCs and distributed compute domains. The mSoC architecture 105 may support N-modular redundancy configurations, heterogeneous and homogeneous compute redundancy, distributed fault containment, fail-operational execution, workload redistribution, and degraded execution operation while maintaining synchronized execution across redundant processing paths. In some implementations, the mSoC architecture 105 supports compliance with automotive safety integrity level (ASIL) and Design Assurance Level (DAL) requirements for autonomous systems, avionics systems, robotics systems, vehicle control systems, and other safety-critical applications.

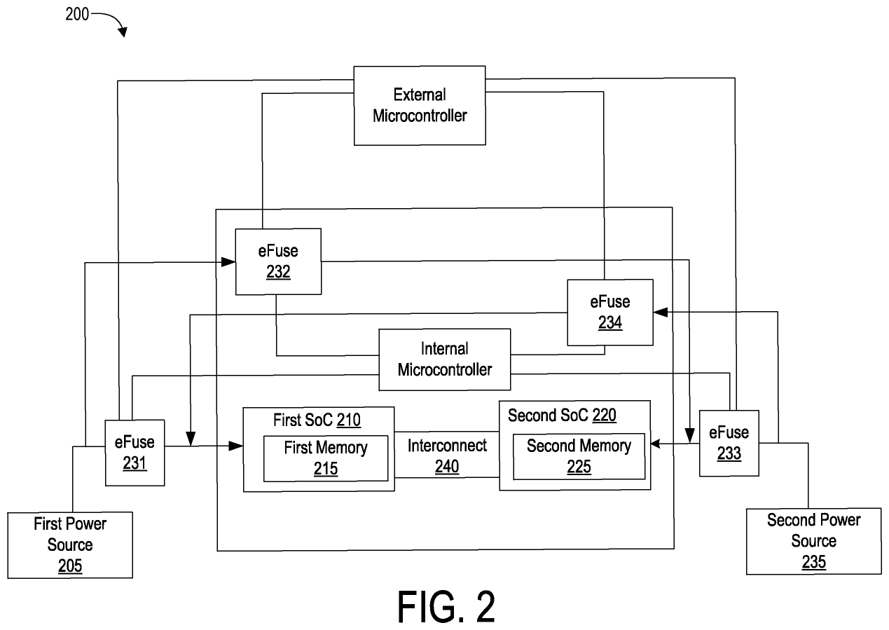

Referring to FIG. 2, FIG. 2 is a block diagram depicting an example computing system 200 implementing a multiple Systems-on-Chip (mSoC), in accordance with examples described herein. In various examples, the computing system 200 can include a first SoC 210 having a first memory 215 and a second SoC 220 having a second memory 225 coupled by an interconnect 240 (e.g., an ASIL-D rated interconnect) that enables each of the first SoC 210 and second SoC 220 to read each other's memories (215, 225). During any given session, the first SoC 210 and the second SoC 220 may alternate roles, between a primary SoC and a backup SoC. As provided herein, the primary SoC can perform various autonomous driving tasks, such as perception, object detection and classification, grid occupancy determination, sensor data fusion and processing, motion prediction (e.g., of dynamic external entities), motion planning, and vehicle control tasks. The backup SoC can maintain a set of computational components (e.g., CPUs, machine learning (ML) accelerators, and/or memory chiplets) in a low power state, and continuously or periodically read the memory of the primary SoC.

In some configurations, the system may also include an external microcontroller for power management, supervisory control, or safety arbitration. This microcontroller may be implemented either on the substrate of the mSoC package or integrated directly on-die within one of the chiplets, enabling low-latency coordination and tightly coupled control infrastructure in support of safety and redundancy goals.

For example, if the first SoC 210 is the primary SoC and the second SoC 220 is the backup SoC, then the first SoC 210 performs a set of autonomous operation tasks and publishes state information corresponding to these tasks in the first memory 215. The second SoC 220 reads the published state information in the first memory 215 to continuously check that the first SoC 210 is operating within nominal thresholds (e.g., temperature thresholds, bandwidth and/or memory thresholds, etc.), and that the first SoC 210 is performing the set of autonomous operation tasks properly. As such, the second SoC 220 performs health monitoring and error management tasks for the first SoC 210, and takes over control of the set of autonomous operation tasks when a triggering condition is met. As provided herein, the triggering condition can correspond to a fault, failure, or other error experienced by the first SoC 210 that may affect the performance of the set of tasks by the first SoC 210.

In some embodiments, the system may include a third, fourth, or additional SoCs, or redundant chiplets distributed across multiple substrates, to provide higher levels of fault tolerance and parallel health verification. These additional SoCs may operate in a multi-layered monitoring arrangement, where each SoC can independently validate outputs, participate in consensus voting, or assume operational control in case of cascading faults or simultaneous failures in two SoCs. This approach scales the mSoC design to meet enhanced safety and availability requirements in domains such as autonomous aviation, space systems, or ASIL-D+ automotive applications.

In various implementations, the second SoC 220 can publish state information corresponding to its computational components being maintained in a standby state (e.g., a low power state in which the second SoC 220 maintains readiness to take over the set of tasks from the first SoC 210). In such examples, the first SoC 210 can monitor the state information of the second SoC 220 by continuously or periodically reading the memory of the second SoC 220 to also perform health check monitoring and error management on the second SoC 220. For example, if the first SoC 210 detects a fault, failure, or other error in the second SoC 220, the first SoC 210 can trigger the second SoC 220 to perform a system reset or reboot.

In certain examples, the first SoC 210 and the second SoC 220 can each include a functional safety (FuSa) component that performs the health monitoring and error management tasks. The FuSa component can be maintained in a powered state for each SoC, whether the SoC operates in a primary or backup manner. As such, the backup SoC may maintain its other components in a low powered state, with its FuSa component being powered up and performing the heath monitoring and error management tasks described herein.

In various aspects, when the first SoC 210 operates as the primary SoC, the state information published in the first memory 215 can correspond to the set of tasks being performed by the first SoC 210. For example, the first SoC 210 can publish any information corresponding to the surrounding environment of the system (e.g., any external entities identified by the first SoC 210, their locations, and predicted trajectories, detected objects, such as traffic signals, signage, lane markings, and crosswalk, and the like). The state information can further include the operating temperatures of the computational components of the first SoC 210, bandwidth usage and available memory of the chiplets of the first SoC 210, and/or any faults or errors, or information indicating faults or errors in these components.

In further aspects, when the second SoC 220 operates as the backup SoC, the state information published in the second memory 225 can correspond to the state of each computational component of the second SoC 220. In particular, these components may operate in a low power state in which the components are ready to take over the set of tasks being performed by the first SoC 210. The state information can include whether the components are operating within nominal temperatures and other nominal ranges (e.g., available bandwidth, power, memory, etc.).

As described throughout the present disclosure, the first SoC 210 and the second SoC 220 can switch between operating as the primary SoC and the backup SoC (e.g., each time the computing system 200 is rebooted). For example, in a computing session subsequent to a session in which the first SoC 210 operated as the primary SoC and the second SoC 220 operated as the backup SoC, the second SoC 220 can assume the role of the primary SoC and the first SoC 210 can assume the role of the backup SoC. It is contemplated that this process of switching roles between the two SoCs can provide substantially even wear of the hardware components of each SoC, which can prolong the lifespan of the computing system 200 as a whole.

According to embodiments, the first SoC 210 can be powered by a first power source 205 and the second SoC 220 can be powered by a second power source 235 that is independent or isolated from the first power source 205. For example, in an electric vehicle, the first power source 205 can comprise the battery pack used for propelling the electric motors of the vehicle, and the second power source 235 can comprise the auxiliary power source of the vehicle (e.g., a 12-volt battery). In other implementations, the first and second power sources (205, 235) can comprise other types of power sources, such as dedicated batteries for each SoC (210, 220) or other power sources that are electrically isolated or otherwise not dependent from each other.

In various implementations, the first SoC 210 and the second SoC 220 may be electrically insulated from each other via a set of one or more eFuses (232, 234), which can be triggered if, for example, a power surge occurs in the system 200. The eFuse 232 and eFuse 234 can comprise a physical fuse (e.g., a microscopic fuse place in the computer chip), a logical fuse consisting of a computer program that trips when current and/or voltage exceeds a specified threshold, or a combination of a physical and logical fuse. In an example scenario, if the second SoC 220 experiences a power surge, eFuse 234 will trip and prevent the same power surge from affecting the first SoC 210. Conversely, if the first SoC 210 experiences a power surge, eFuse 232 will trip and prevent the same power surge from affecting the second SoC 220. Thus, if a power surge occurs, at least one of the SoCs will remain operational (e.g., and operate as the primary SoC), while the SoC that has experienced the power surge can reboot or reset and/or operate as the backup SoC.

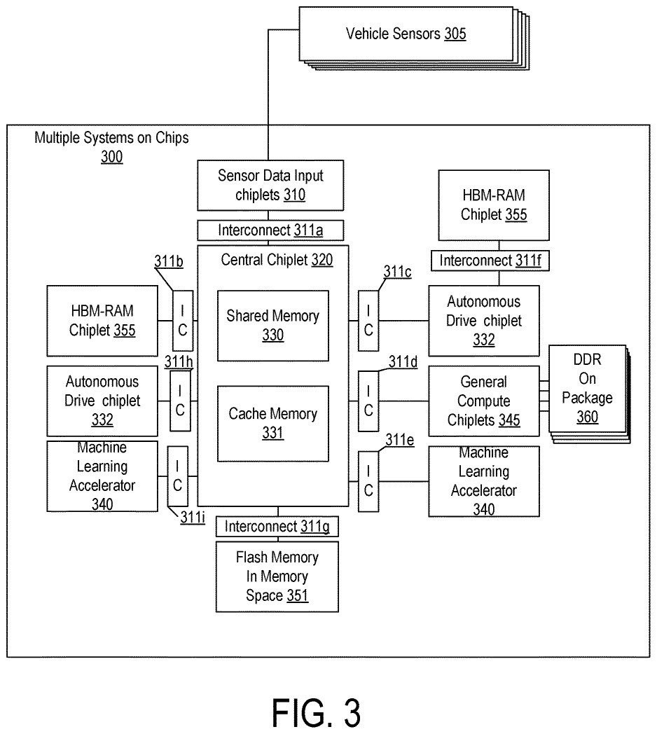

It is contemplated that the multiple Systems-on-Chip (mSoC) arrangement of the computing system 200 can be provided to increase the safety integrity level (e.g., ASIL rating) of the computing system 200 and the overall autonomous driving system of the vehicle. As described herein, the autonomous system can include any number of dual SoC arrangements, each of which can perform a set of autonomous operation tasks. In doing so, the backup SoC dynamically monitors the health of the primary SoC in accordance with a set of functional safety operations, such that when a fault, failure, or other error is detected, the backup SoC can readily power up its components and take over the set of tasks from the primary SoC. A further description of the SoCs and their computational components is provided below with respect to FIG. 3.

Referring to FIG. 3, FIG. 3 is a block diagram illustrating an example implementation of multiple SoC 300, in accordance with examples described herein. The Multiple SoC 300 may correspond to either the first SoC 210 or the second SoC 220 described in connection with FIG. 2, depending on which is active in a given operational cycle.

It is noted that the configuration depicted in FIG. 3 represents one of several possible architectural variants. The actual SoC implementation may incorporate additional chiplets beyond the minimum required for nominal task execution. These surplus chiplets may serve to enable redundancy-based voting, facilitate cross-verification of algorithmic outputs, and provide computational diversity for example, through the use of different instruction sets, neural network models, or architectural specializations.

This redundancy and heterogeneity allow the system to enhance functional safety, support diverse algorithmic inference paths, and improve resilience to both systematic and random hardware faults. Therefore, while FIG. 3 provides a representative block-level overview, it is offered solely for illustrative purposes and does not limit the scope of the present disclosure to the particular layout or component count shown.

As illustrated in FIG. 3, the multiple SoC 300 may include one or more dedicated sensor data input chiplets 310, which are responsible for interfacing with external vehicle sensors 305. These sensors may include image sensors (e.g., monocular, stereo, fisheye cameras), LiDAR, radar, ultrasonic, and other modalities critical to perception. The sensor input chiplets act as specialized I/O interfaces and are designed to ingest raw sensor data and forward it to the central chiplet 320, typically through a high-speed interconnect for processing and caching in a cache memory 331.

Importantly, not all chiplets within the multiple SoC 300 include direct I/O capabilities. To maintain high availability and safety integrity, the architecture may incorporate multiple I/O chiplets, providing redundant data paths for critical input sources. This design allows the system to perform cross-validation and voting between input channels, and ensures that at least one input path remains active and trusted in the event of chiplet-level failure, isolation, or degraded operation.

This redundancy in I/O is essential for systems targeting functional safety standards such as ISO 26262 ASIL-D or RTCA DO-254 DAL-A, where loss of input connectivity or unverified perception data could compromise overall system safety or mission assurance.

In some aspects, the sensor data input chiplets 310 publish identifying metadata for each unit of sensor data (e.g., image frames, LiDAR point clouds, radar sweeps, etc.) to a shared memory 330 located within a central chiplet 320. This shared memory functions as a centralized mailbox and scheduler, enabling workload coordination across the various chiplets within the SoC. The identifying information may include the memory address of the cached data (e.g., in cache memory 331), the sensor type, the originating sensor identifier, and a timestamp indicating when the data was acquired.

In more advanced implementations, the central chiplet 320 may itself be composed of two or more interconnected chiplets, providing load-balancing, fault tolerance, and parallel scheduling capabilities. This dual-chiplet configuration improves resiliency, especially in safety-critical environments where mailbox shadowing, task duplication, and arbitration are needed.

Additionally, the mSoC architecture can include multiple machine learning accelerators 340 (alternatively referred to as ML chiplets), as well as multiple memory, such as high-bandwidth memory modules, HBM-RAM chiplet 355 or DDR modules on substrate dedicated to machine learning tasks. These components enable parallel or ensemble-based inference, improve throughput, and support redundancy voting across independently computed results. This redundancy across ML execution and data storage also strengthens the system's ability to detect and isolate anomalies in inference output, bolstering overall functional safety and algorithmic diversity.

To communicate with the central chiplet 320, the sensor data input chiplets 310 transmit data through an interconnect 311a. Each of the interconnects 311a-311i represents a die-to-die (D2D) communication interface between chiplets within the multiple SoC 300. These interconnects serve dual purposes: a high-bandwidth data path for transferring sensor data (e.g., to cache memory 331) and a high-integrity, low-latency control path used for transmitting functional safety (FuSa) signals, scheduler coordination, and mailbox updates to shared memory 330.

To meet differing performance and reliability requirements, some interconnects such as 311a may be implemented with multiple parallel lanes or redundant links, supporting both throughput scaling and fault resilience. For instance, interconnect 311a may include dual interfaces to ensure reliable and uninterrupted communication between the sensor data input chiplets 310 and the central chiplet 320, especially in configurations where the central chiplet is composed of two cooperating chiplets for load balancing and functional safety redundancy. These scalable, fault-aware interconnects are critical for maintaining deterministic behavior and supporting ASIL-D or DO-254 levels of reliability in safety-critical applications.

In one aspect, the interconnects 311a-311i conform to the Universal Chiplet Interconnect Express (UCIe) standard and operate in indirect mode, enabling chiplet host processors to access remote memory as if it were local. This capability is made possible by a specialized Network-on-Chip (NoC) Network Interface Unit (NIU), which facilitates hardware-level support for remote direct memory access (RDMA) operations.

In this mode, a host processor issues memory access requests to its local NIU, which then performs the necessary address translation, routing, and transaction protocols to retrieve or update data stored in a remote memory region typically located on another chiplet. The requested data is then returned to the host processor with minimal latency and overhead.

UCIe or any other interconnect indirect mode enhances system performance in distributed computing environments, particularly in mSoC designs where data locality and functional partitioning span multiple chiplets. Furthermore, it supports a wide range of network topologies and protocol abstractions, offering designers the flexibility to build scalable, heterogeneous systems that maintain low-latency inter-chiplet communication without sacrificing isolation or modularity.

In various implementations, the System-on-Chip (SoC) 300 may incorporate additional specialized chiplets designed to store, process, or transform the sensor data initially cached by the sensor input chiplet 310. Among these, an autonomous drive chiplet 332 may be included to perform critical perception and decision-making functions such as sensor fusion, environmental understanding, trajectory prediction, and other algorithms required for real-time operation of an autonomous system.

The autonomous drive chiplet 332 is typically paired with a dedicated high-bandwidth memory HBM-RAM chiplet 355, which acts as a fast-access storage region for status information, intermediate variables, statistical data, and processed sensor inputs. By offloading memory-intensive operations to the HBM chiplet, the autonomous operation chiplet can maintain high throughput and low latency, even under computationally demanding workloads. This chiplet-level modularity enables parallel development, targeted fault isolation, and performance scaling, all of which are critical in safety-certified mSoC architectures.

In various implementations, the System-on-Chip (SoC) 300 may further include one or more machine learning (ML) accelerator chiplets, such as ML chiplet 340, specialized for accelerating AI workloads. These workloads may include image inference, sensor data interpretation, object classification, and other perception tasks that benefit from parallelized machine learning execution. Each ML accelerator chiplet is equipped with an engine optimized to handle graph-based data structures commonly used in AI and a highly parallel processing architecture designed to deliver high throughput with low power consumption.

To meet functional safety requirements, the mSoC architecture may include redundant ML accelerator chiplets operating either in parallel or in voting mode. In a voting configuration, multiple ML chiplets execute the same model or diversified versions of a model, and their inference outputs are compared by a voting or arbitration unit often coordinated through the central chiplet mailbox system. If discrepancies are detected, the system can flag the inconsistency, isolate the faulty chiplet via eFuse deactivation, or fall back to a known-good inference path.

These ML chiplets also include specialized hardware blocks for AI operations such as matrix multiplication, convolution, and activation functions, along with an optimized multi-tier memory hierarchy that reduces latency during complex AI workloads. This architecture enables high-reliability AI inference while supporting certification under standards such as ASIL-D and DO-254 DAL-A, through the inclusion of redundant execution and real-time verification mechanisms.

The general compute chiplets 345 serve as flexible, high-performance processing units within the multiple SoC 300, providing general-purpose computing capabilities across the platform. These chiplets may integrate high-performance CPU cores, vector processors, and optionally GPUs, enabling them to assist or offload tasks from the central chiplet 320, the autonomous drive chiplet 332, or the ML chiplets (machine learning accelerator 340). They are particularly well-suited for non-specialised workloads, overflow compute tasks, and system management functions, and may also participate in redundancy configurations where compute voting or failover logic is employed. In some implementations, the system further includes DDR on package 360 coupled to the general compute chiplets 345. The DDR on package 360 provides high-speed memory to support execution of the set of tasks and storage of intermediate computational data.

The shared memory 330, located within the central chiplet 320, stores program instructions, execution metadata, and resource allocation structures necessary for coordinating autonomous operation tasks across chiplets. This includes a reservation table that provides execution agents (i.e., chiplets) with access to task-critical metadata such as sensor data identifiers, data locations, processing priorities, and scheduling time windows. The shared memory supports deterministic behavior and synchronizes inter-chiplet task execution, particularly in mSoC designs with distributed functional safety features.

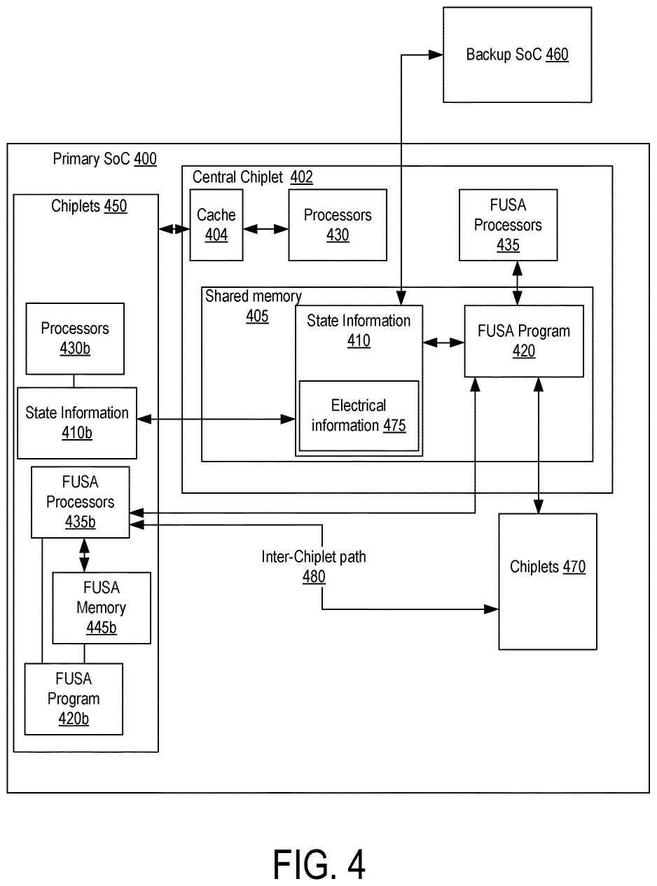

To support fast-access and coherent data management, the central chiplet also includes a cache memory 331, capable of handling invalidate and flush operations. This enables consistent memory views across chiplets and supports state preservation during chiplet handovers or degraded-mode transitions. Additional details on the structure and interaction of the shared memory 330 in dual-SoC configurations are provided in reference to FIG. 4.

Cache misses and data evictions from the cache memory 331 of the central chiplet 320 are directed to a high-bandwidth memory, (HBM-RAM chiplet 355), which serves as a secondary, high-capacity storage resource within the multiple SoC 300. The HBM chiplet 355 stores status snapshots, intermediate variables, sensor-derived data, and statistical information generated by or shared across other chiplets in the mSoC. In typical implementations, this data may be retained for a predetermined duration (e.g., 10 seconds) before being flushed or overwritten, allowing the system to retain a rolling diagnostic window useful for fault detection, mitigation, and post-event analysis. In some implementations, the central chiplet 320 is further coupled, via interconnect 311g, to a flash memory in memory space 351 configured to store non-volatile data, including firmware, state information, and intermediate computational data to support operation of the system.

In some configurations, the HBM-RAM chiplet 355 may be supplemented or replaced with other types of on-package memory technologies, such as DDR-based memory, volatile DRAM modules, or even non-volatile flash memory, depending on system requirements. These alternative memory modules can also be used to store machine learning models, either statically loaded at boot or dynamically swapped during runtime via trusted update paths. This flexibility allows for optimized performance across diverse workloads while maintaining real-time availability of inference models and ensuring model version traceability under safety-critical constraints. The cache memory 331 remains optimized for low-latency, low-power access to high-priority, frequently accessed data minimizing dependence on off-chip memory and enabling faster turnaround for real-time processing tasks.

In various implementations, the shared memory 330 within the central chiplet 320 serves as a coordination hub for chiplet-level task execution. It stores the program code, scheduling metadata, and system-level state necessary for orchestrating autonomous operation tasks across the mSoC. Among its key structures is a reservation table, which provides chiplets with context-specific execution directives such as sensor data references, memory addresses, task priorities, and execution time windows that are essential for synchronizing parallel workloads.

This centralized yet accessible memory model ensures consistent task execution and is especially critical in dual-SoC configurations, where primary and secondary SoCs may alternate control roles or operate in shadow mode. The reservation table is dynamically updated to reflect the current operational state, enabling either SoC to take over seamlessly in the event of a fault. A detailed explanation of how the shared memory 330 facilitates state duplication, scheduling handoff, and shadowing in mSoC architectures is provided in conjunction with FIG. 4.

Referring to FIG. 4, FIG. 4 is a block diagram depicting an example central chiplet 402 of a primary SoC 400 that includes a shared memory 405 for implementing duplicated status and shadowing for multiple SoCs, according to examples described herein. The central chiplet 402 shown in FIG. 4 can correspond to the central chiplet 320 of the multiple SoC 300 as shown and described with respect to FIG. 3. Furthermore, the chiplets 450 shown with respect to FIG. 4 can correspond to one or more of the sensor data input chiplets 310, autonomous drive chiplet 332, general compute chiplets 345, or machine learning (ML) accelerator chiplet 340 of FIG. 3.

As used herein, the terms “primary SoC” and “backup SoC” are used for illustrative purposes to describe operational roles of the system-on-chip devices. It should be understood that the “primary SoC 400” may correspond to the “first SoC,” and the “backup SoC 460” may correspond to the “second SoC,” as described elsewhere in the specification. These designations are interchangeable and may vary depending on operational state, including role switching between the SoCs. Accordingly, the use of “primary” and “backup” does not limit the structural or functional scope of the “first SoC” and “second SoC,” and either SoC may perform the functions attributed to the other.

Referring to FIG. 4, the central chiplet 402 of a primary SoC 400 can include a shared memory 405 that stores state information 410 published by a set of processors 430 of the central chiplet 402 as well as the chiplets 450 of the primary SoC 400. In addition, state information 410b can be generated by processors 430b of the backup SoC 460. In various examples, the set of processors 430 and the chiplets 450 perform the set of tasks (e.g., autonomous operation tasks) and publish state information 410 corresponding to those tasks in the shared memory 405 of the central chiplet 402. Additionally, or alternatively, the set of processors 430 and the chiplets 450 can publish the state information 410 corresponding to the set of tasks in a cache 404 of the central chiplet. As provided herein, the state information 410 can comprise any information needed for a backup SoC 460 to take over the set of tasks. This can include statistical information corresponding to the surrounding environment of the autonomous system (e.g., the last images from cameras, last datasets from other sensors, classified objects, their locations, localization information, etc.), as well as performance data of the hardware components of the primary SoC 400 (e.g., bandwidth, temperature, memory information). In some implementations, the state information 410 includes electrical information 475 corresponding to operational parameters of one or more components of the SoC.

In embodiments, the backup SoC 460 may have direct access to both the shared memory 405 and cache 404, allowing it to retrieve this data and immediately resume operations if a failure is detected in the primary SoC. The backup SoC 460 may also include a sensor data input chiplet with direct connectivity to system sensors, which becomes fully activated upon role transition to maintain uninterrupted data ingestion. To coordinate such transitions safely and deterministically, the system utilizes a mailbox architecture distributed across the chiplets that supports task shadowing, workload voting, and schedule validation. Each chiplet may also be supported by one or more redundant chiplets, which can be exact replicas or design-diverse equivalents performing the same function. These redundant chiplets may reside on the same substrate within the SoC or exist on separate SoCs within the mSoC configuration. During runtime, the mailbox system facilitates consistency checks and voting logic across these redundant compute elements, and if any inconsistency or anomalous behavior is detected, the system can trigger a degraded workload profile, initiate eFuse isolation of the faulty component, or escalate a role handoff to the backup SoC, preserving system integrity and safety at all times.

In various examples, the shared memory 405 can include a functional safety (FuSa) program 420 that performs health monitoring and error management operations for the primary SoC 400 as well as the backup SoC 460. Likewise, the backup SoC 460 can also include a set of chiplets and a central chiplet with a shared memory (or cache) in which the components of the backup SoC 460 publish state information 410b. The central chiplet of the backup SoC 460 can further include FuSa components for performing health monitoring and error management tasks for the backup SoC 460, as well as having direct memory access to the state information 410 of the primary SoC 400. These FuSa components not only oversee the health of the backup SoC but also maintain direct memory access to the state information 410 published by the primary SoC 400, allowing real-time shadowing and error tracking. This architecture ensures that both SoCs remain continuously aware of each other's operational status, and through the distributed mailbox system, the FuSa logic can synchronize error assessments, confirm expected workload performance, and initiate mitigation procedures such as task degradation, component isolation via eFuse, or a coordinated role reversal when a failure threshold is reached.

In various implementations, the FuSa program 420 of the primary SoC 400 can access the shared memory of the backup SoC 460 to dynamically read the state information of the backup SoC 460. In further implementation, the FuSa program of the backup SoC 460 can access and dynamically read the state information 410 in the shared memory 405 of the primary SoC 400. When a triggering event occurs (e.g., a fault or failure), as detected in the state information 410 by the FuSa program of the backup SoC 460, the backup SoC 460 can take over the set of tasks being performed by the primary SoC 400. Thereafter, the primary SoC 400 may reboot or reset the component(s) experiencing the fault or failure or can reboot or reset the primary SoC 400 itself, and assumes the role of backup SoC.

In such implementations, the primary SoC 400 can power down the chiplets 450 and/or the processors 430 of the central chiplet 402 and can maintain the powered-up state for the FuSa processor 435 to execute the FuSa program 420 and monitor the state information published by the SoC 460 in its own shared memory or cache. Accordingly, in autonomous applications, the autonomous tasks previously performed by the primary SoC 400, can be seamlessly transferred to the backup SoC 460 when the triggering event in the state information 410 is detected by the backup SoC 460. In addition, a FuSa memory 445b is distributed across one or more of the chiplets 450 and configured to store a synchronized copy of the state information 410 published to the shared memory 405. This redundant FuSa memory allows the SoC to continue functioning and reconstruct operational context in the event of a malfunction or shutdown of the central chiplet 402. To facilitate this redundancy, the chiplets 450 are interconnected using a communication fabric represented by inter-chiplet path 480. In case of central chiplet 402 failures, the chiplets can exchange state information and control signals over the inter-chiplet path 480, allowing the system to reconstruct task scheduling and maintain autonomous operation even when the central chiplet is turned off by its associated eFuses. In corresponding implementations, processors 430b of the backup SoC 460 can be maintained in a low-power state or activated based on operational role.

In various examples, the shared memory 405 can include a functional safety (FuSa) program 420 that performs health monitoring and error management operations for the primary SoC 400 as well as the backup SoC 460. Likewise, the backup SoC 460 can also include a set of chiplets and a central chiplet with a shared memory (or cache) in which the components of the backup SoC 460 publish state information. The central chiplet of the backup SoC 460 can further include FuSa components for performing health monitoring and error management tasks for the backup SoC 460, as well as having direct memory access to the state information 410 of the primary SoC 400. In certain examples, the FuSa components can include a dedicated FuSa processor 435 to execute the FuSa program 420 and perform the health monitoring and error management functions described throughout the present disclosure.

In various implementations, the functional safety (FuSa) program 420 of the primary SoC 400 can access the shared memory of the backup SoC 460 to dynamically read the state information of the backup SoC 460. In further implementations, the FuSa program 420b of the backup SoC 460 can access and dynamically read the state information 410 in the shared memory 405 of the primary SoC 400. When a triggering event occurs (e.g., a fault or failure), as detected in the state information 410 by the FuSa program of the backup SoC 460, the backup SoC 460 can take over the set of tasks being performed by the primary SoC 400. Thereafter, the primary SoC 400 may reboot or reset the component(s) experiencing the fault or failure or can reboot or reset the primary SoC 400 itself, and assumes the role of backup SoC 460. In some implementations, chiplets 470 represent one or more computational components configured to process state information and support functional safety operations within the system.

In such implementations, the primary SoC 400 can power down the chiplets 450 and/or the processors 430 of the central chiplet 402 and can maintain the powered-up state for the functional safety (FuSa) processor 435 to execute the FuSa program 420 and monitor the state information published by the SoC 460 in its own shared memory or cache. With the addition of FuSa memory 445b and inter-chiplet communication via the inter-chiplet path 480, the system retains the ability to operate even in the absence of a functional central chiplet, enabling reconstruction of the execution schedule from distributed state information. Accordingly, in autonomous applications, the autonomous tasks previously performed by the primary SoC 400, can be seamlessly transferred to the backup SoC 460 when the triggering event in the state information 410 is detected by the backup SoC 460. In some embodiments, the FuSa processor 435b operates in association with the FuSa memory 445b and the FuSa program 420b to monitor health information, synchronization information, and operational status associated with the chiplets 450 and the backup SoC 460 during failover, degraded execution, and distributed monitoring operations.

In further embodiments, each time the SoCs (400, 460) are rebooted, they can switch between the role of primary SoC and backup SoC to provide substantially even wear of the hardware components of each SoC 400, 460. This approach not only extends the overall operational lifespan of the mSoC architecture but also enables predictive maintenance through evenly distributed duty cycles. The configuration illustrated in FIGS. 2, 3, and 4 provides inherent redundancy and fault containment, by increasing system reliability when performing safety-critical tasks.

The architectural elements such as distributed functional safety memory, chiplet-level isolation via eFuses, and synchronized state monitoring via mailbox-based coordination are key enablers for achieving an elevated Automotive Safety Integrity Level (ASIL) classification, such as ASIL-D under ISO 26262. Moreover, the same mechanisms align with the stringent certification requirements of aerospace and avionics safety standards, including RTCA DO-254 Design Assurance Level (DAL) A/B. In avionics applications, where flight control or mission-critical autonomy mandates determinism and resilience to cascading failures, the mSoC's distributed scheduling, role-swapping redundancy, and cross-SoC validation protocols help ensure continued safe operation, even in the presence of component degradation. These capabilities support the certification paths for embedded systems used in both advanced driver assistance and next-generation avionics, establishing a unified safety model across automotive and aerospace domains.

Referring to FIG. 5 and FIG. 6A-6C, FIGS. 5 and 6A-6C are flow charts describing methods of implementing duplicated status, shadowing, and cross-verification for multiple SoCs, according to the examples described herein. In the discussion of the methods associated with FIGS. 5 and 6A-6C, reference may be made to identifiers and component relationships described with respect to the system diagrams in FIGS. 1 through 4. Furthermore, the steps illustrated in the flow charts of FIGS. 5 and 6A-6C may be performed by the computing systems (100 and 200) and the multiple Systems-on-Chip (mSoC) configurations described throughout this disclosure. Certain actions may be executed prior to, concurrently with, or after other actions and need not follow the precise sequence shown.

FIG. 5 illustrates an exemplary process for performing distributed monitoring, state synchronization, redundant execution, distributed validation, and failover operations across multiple System-on-Chip (SoC) devices within a multiple Systems-on-Chip (mSoC) architecture. In some embodiments, the process is implemented using distributed mailbox subsystems, cross-SoC state sharing, scheduler synchronization, and distributed voting operations to provide fail-operational behavior and fault-tolerant execution for safety-critical workloads.

At block 500, a first SoC performs a set of computational tasks. The set of computational tasks may include autonomous system workloads, enterprise logic, machine learning inference operations, sensor processing operations, object detection operations, occupancy determination, motion prediction, trajectory planning, robotics control operations, avionics operations, functional safety operations, or other safety-critical workloads. In some implementations, the first SoC executes the workloads using multiple chiplets distributed across corresponding compute domains.

At block 505, the first SoC publishes state information corresponding to the set of tasks into a memory associated with the first SoC. In some embodiments, the published state information includes task execution context, register information, queue information, workload scheduling information, synchronization information, intermediate computational results, model or algorithm state information, timing information, environmental statistics, thermal information, power telemetry, chiplet health information, mailbox information, voting status information, diagnostic information, or machine state information associated with execution of the workloads by the first SoC. The state information may be continuously updated during runtime operation to support synchronization, failover readiness, and distributed validation across multiple SoCs.

At block 507, a third SoC dynamically reads the state information and scheduler information associated with the first SoC and locally schedules corresponding workloads for redundant execution. In some embodiments, the third SoC operates as a shadow-verification or redundant execution unit configured to independently execute or validate workloads corresponding to workloads performed by the first SoC. The third SoC may perform runtime validation, synchronization analysis, execution comparison, workload sequencing verification, timing validation, or voting-related validation operations to ensure correctness, determinism, and redundancy across multiple compute domains and heterogeneous hardware implementations.

At block 510, a second SoC continuously reads the memory of the first SoC to determine an operational state of the first SoC. In some embodiments, the second SoC monitors runtime execution state, workload status information, synchronization information, timing behavior, health information, mailbox information, voting information, or diagnostic information associated with the first SoC. The second SoC may therefore validate operational correctness and maintain readiness to assume execution responsibility in response to one or more detected fault conditions.

At block 515, the second SoC maintains a plurality of computational components in a low-power state while maintaining a synchronized copy of the machine state associated with the first SoC. In some embodiments, the computational components maintained in the low-power state include one or more autonomous operation chiplets, general compute chiplets, machine learning accelerator chiplets, memory chiplets, sensor processing chiplets, or scheduling chiplets. The second SoC may maintain synchronized copies of workload state information, execution context information, synchronization information, and intermediate computational results corresponding to workloads executed by the first SoC. In certain implementations, the synchronized shadow-state replication enables immediate context restoration and workload reassignment upon detection of a trigger condition.

At block 520, the second SoC detects a trigger associated with the first SoC based on monitoring the published state information. In some embodiments, the trigger corresponds to a fault, failure, runtime anomaly, synchronization mismatch, thermal violation, watchdog timeout condition, power fluctuation, execution inconsistency, memory corruption event, communication failure, interconnect failure, chiplet-specific failure, scheduling mismatch, voting discrepancy, or published error condition associated with the first SoC. In certain implementations, the third SoC continuously analyzes scheduler information, execution outputs, workload graphs, or synchronization information associated with the first SoC to perform cross-check validation and identify non-recoverable discrepancies in execution behavior.

At block 525, in response to detecting the trigger or loss of communication with the first SoC, the second SoC activates computational components previously maintained in the low-power state and performs the set of tasks associated with the first SoC. In some embodiments, the second SoC resumes execution using the synchronized state information maintained during monitoring operations, thereby enabling fail-operational continuation of the workloads without requiring complete workload restart or reconstruction of execution state. The third SoC may subsequently transition its monitoring and validation operations to monitor execution of the second SoC. The coordinated failover and distributed monitoring operations therefore maintain continuous fault tolerance, runtime redundancy, synchronized execution, and real-time system integrity across the mSoC architecture.

FIGS. 6A, 6B, and 6C illustrates a flow chart describing a further method of implementing duplicated status and shadowing for a dual or multi-SoC arrangement, in accordance with examples described herein.

FIG. 6A, FIG. 6B, and FIG. 6C illustrate an exemplary distributed fault detection, degradation management, workload redistribution, and failover process implemented across a primary mSoC 604, a secondary mSoC 606, and a third mSoC 608 respectively within a multiple Systems-on-Chip (mSoC) architecture. In some embodiments, the process illustrated in FIG. 6A-6C enables distributed monitoring, chiplet-level fault isolation, degraded execution management, coordinated failover, workload synchronization, and distributed recovery operations across multiple SoCs and chiplet-based compute domains.

As illustrated in FIG. 6A, the primary mSoC 604 may directly receive sensor data at block 600. The sensor data may include camera data, radar data, lidar data, ultrasonic data, inertial measurement data, navigation data, avionics sensor data, robotics sensor data, industrial telemetry data, or other environmental and operational information associated with operation of a safety-critical system. At block 605, the primary mSoC 604 performs one or more autonomous driving tasks or other computational workloads based on the received sensor data. The workloads may include sensor processing, sensor fusion, object detection, object classification, occupancy estimation, machine learning inference operations, trajectory planning, motion prediction, actuator control, or autonomous control operations.

At block 610, the primary mSoC 604 publishes state information corresponding to the autonomous driving tasks or other workloads. In some embodiments, the published state information includes execution context information, register information, workload scheduling information, synchronization information, mailbox information, voting status information, machine learning inference information, health information, timing information, chiplet status information, environmental statistics, or intermediate computational results associated with execution of workloads by the primary mSoC 604.

At block 615, the primary mSoC 604 continuously reads state information associated with the secondary mSoC 606 and the third mSoC 608 to monitor synchronization, execution integrity, operational health, and failover readiness across the distributed compute architecture. In some implementations, the cross-SoC monitoring operations include distributed mailbox synchronization, voting-state synchronization, workload coordination, execution validation, and runtime arbitration operations.

At decision block 620, the primary mSoC 604 determines whether a trigger condition, synchronization anomaly, voting discrepancy, execution inconsistency, or fault condition exists in the secondary mSoC 606 or the third mSoC 608 based on the continuously monitored state information. If no trigger condition is detected, the process returns to block 615, and the primary mSoC 604 continues monitoring state information associated with the secondary mSoC 606 and the third mSoC 608. If a trigger condition is detected, the process proceeds to block 625.

In certain embodiments, the primary mSoC 604 further performs chiplet-level diagnostic operations. At block 601, the primary mSoC 604 diagnoses individual chiplets associated with the primary mSoC 604 to identify chiplet degradation, communication failures, synchronization mismatches, thermal anomalies, timing violations, memory faults, electrical anomalies, or workload execution inconsistencies. At decision block 602, the primary mSoC 604 determines whether a trigger condition or fault condition exists. If no trigger condition is detected, the monitoring and diagnostic operations continue. If a trigger condition is detected, the process proceeds to block 603.

At block 603, the primary mSoC 604 performs a health assessment operation to identify one or more chiplets reporting issues or failing to report status information. In some implementations, the health assessment includes mailbox analysis, voting discrepancy analysis, scheduler integrity verification, synchronization validation, power monitoring, timing analysis, or diagnostic status verification associated with corresponding chiplets and compute domains.

At block 625, the primary mSoC 604 transmits a command to the secondary mSoC 606 to initiate reboot, reset, failover, or eFuse control operations. In some embodiments, the command instructs the secondary mSoC 606 to activate computational resources and assume execution responsibility for one or more workloads associated with the primary mSoC 604. At block 675, the primary mSoC 604 performs backup monitoring of the secondary mSoC 606 after workload transition or failover operations. In some embodiments, the backup monitoring operation includes continuously validating synchronization information, workload execution status, mailbox information, health information, and voting information associated with the secondary mSoC 606 after failover or workload reassignment.

In some embodiments, the primary mSoC 604 further supports degraded execution operation. At block 685, the primary mSoC 604 configures execution for operation with one or more degraded or unavailable chiplets. In certain implementations, workload redistribution, scheduling adjustments, execution graph modifications, and compute reassignment operations are performed to maintain continued operation despite degradation of one or more compute domains. At block 676, the primary mSoC 604 loads a precomputed semaphore graph or degraded execution configuration corresponding to the degraded compute topology. The degraded execution configuration may define workload reassignment rules, synchronization relationships, execution dependencies, failover priorities, voting relationships, or resource allocation policies associated with degraded operation.

In some embodiments, the primary mSoC 604 further communicates with electrical isolation circuitry or eFuse circuitry at block 686 to selectively power off or isolate one or more misbehaving chiplets. The electrical isolation operations may disconnect power rails, interconnect paths, communication interfaces, or compute domains associated with faulty chiplets to prevent propagation of electrical faults or execution anomalies across the distributed compute architecture.

As further illustrated in FIG. 6B, the secondary mSoC 606 maintains a plurality of computational components in a low-power state at block 630 while continuously monitoring execution information associated with the primary mSoC 604 and the third mSoC 608. At block 635, the secondary mSoC 606 continuously reads state information associated with the primary mSoC 604 and the third mSoC 608 to maintain synchronized execution context information and failover readiness.

At decision block 640, the secondary mSoC 606 determines whether a trigger condition exists. If no trigger condition is detected, the secondary mSoC 606 continues monitoring operations. If a trigger condition is detected, the process proceeds to block 645. At block 645, the secondary mSoC 606 powers up computational components previously maintained in low-power states and takes over execution of workloads associated with a failing SoC. In some embodiments, the workload takeover operation utilizes synchronized state information dynamically maintained during monitoring operations.

At block 650, the secondary mSoC 606 reads state information associated with the primary mSoC 604 and the third mSoC 608 to evaluate synchronization integrity, workload continuity, and degraded execution status after failover operations. At decision block 660, the secondary mSoC 606 determines whether the system remains in a degraded operational condition. If the system remains degraded, the process proceeds to block 665. If the system is no longer operating in a degraded condition, the process may proceed to block 666 to continue distributed health monitoring and scheduler management operations.

At block 665, the secondary mSoC 606 initiates mitigation operations or emergency response operations. In some embodiments, the mitigation operations include workload throttling, degraded execution operation, reduced-performance operation, selective workload disablement, hazard mitigation, safety-mode activation, or emergency control operations associated with autonomous systems, vehicle systems, robotics systems, or avionics systems.

In certain embodiments, the secondary mSoC 606 further performs distributed health analysis and scheduler adaptation operations. At block 666, the secondary mSoC 606 checks operational health associated with the primary mSoC 604 and the third mSoC 608. The health analysis may include mailbox analysis, scheduler consistency analysis, voting discrepancy analysis, synchronization analysis, runtime integrity validation, timing analysis, or chiplet diagnostic verification. At block 667, the secondary mSoC 606 adjusts one or more trigger conditions or scheduling configurations to maintain operation with one or more degraded chiplets or compute domains on the primary mSoC 604. In some implementations, workload scheduling operations are dynamically modified to support degraded execution operation with reduced computational resources.

At block 668, the secondary mSoC 606 loads a degraded software scheme or degraded execution configuration corresponding to the current degraded operating condition associated with the primary mSoC 604. The degraded software scheme may include modified execution graphs, workload redistribution policies, synchronization configurations, failover mappings, voting relationships, or resource allocation configurations associated with degraded operation.

At block 670, the secondary mSoC 606 transmits one or more commands to the primary mSoC 604 or the third mSoC 608 to resume computation, redistribute workloads, synchronize execution states, or participate in coordinated failover and recovery operations across the distributed compute architecture.

As further illustrated in FIG. 6C, the third mSoC 608 may directly receive sensor data at block 600c and perform autonomous driving tasks or other workloads at block 605c. At block 610c, the third mSoC 608 publishes state information corresponding to the workloads. At block 615c, the third mSoC 608 continuously reads state information associated with the primary mSoC 604 and the secondary mSoC 606 to maintain synchronized execution and distributed monitoring operations.

At decision block 620c, the third mSoC 608 determines whether a trigger condition, synchronization anomaly, voting discrepancy, workload mismatch, or fault condition exists in the primary mSoC 604 or the secondary mSoC 606 based on monitored state information. If no trigger condition is detected, the process returns to block 615c and the third mSoC 608 continues distributed monitoring operations. If a trigger condition is detected, the third mSoC 608 transmits one or more commands to the secondary mSoC 606 at block 625c to cause the secondary mSoC 606 to take over workloads associated with the primary mSoC 604 or the third mSoC 608. At block 675c, the third mSoC 608 performs reboot, recovery analysis, diagnostic analysis, or failure analysis operations associated with a failed SoC or degraded compute domain.

In some embodiments, the third mSoC 608 further performs chiplet-level diagnosis operations at block 690 and determines whether one or more trigger conditions exist at decision block 691. If a trigger condition is detected, the third mSoC 608 performs a health assessment operation at block 693 to identify one or more chiplets reporting faults, synchronization failures, degraded execution behavior, or missing status information.

At block 692, the third mSoC 608 updates one or more peer SoCs with results of computation, synchronization information, health information, voting status information, or workload status information associated with distributed execution operations. At block 687, the third mSoC 608 computes workloads corresponding to workloads executed by the primary mSoC 604 to support redundant execution verification, distributed arbitration, synchronization validation, or voting-based execution comparison operations across multiple SoCs. In some embodiments, the computation performed at block 687 enables independent verification of workload execution results generated by the primary mSoC 604 to facilitate distributed majority voting and consensus validation across redundant processing paths.

At block 688, the third mSoC 608 communicates with electrical isolation circuitry or eFuse circuitry to selectively power off or isolate one or more misbehaving chiplets or compute domains. The eFuse operations may support fault containment, electrical isolation, workload protection, and prevention of cascading failures across the distributed mSoC architecture.

The distributed operations illustrated in FIG. 6A-6C therefore enable coordinated monitoring, synchronized workload execution, distributed voting, dynamic workload redistribution, degraded execution operation, electrical fault isolation, deterministic failover, and fail-operational behavior across multiple SoCs and distributed chiplet-based compute domains.

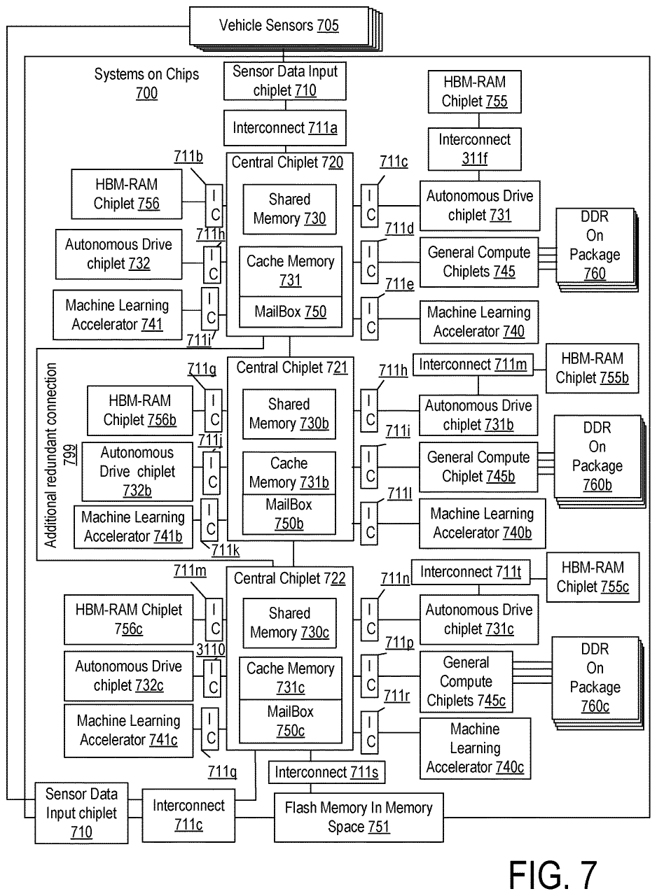

Referring to FIG. 7, FIG. 7 illustrates a multiple-central-chiplet mSoC architecture in which each subsystem is integrated into a unified substrate rather than being distributed across multiple separate SoCs. This configuration enables internal voting and redundancy directly within the same mSoC package, improving latency, power efficiency, and system safety. In some embodiments, the multiple SoCs and corresponding chiplets may be implemented within a same substrate or die package to support N-modular redundancy voting across redundant processing paths. Each SoC device may comprise a corresponding mailbox subsystem and coordination chiplet configured to participate in distributed consensus determination, workload coordination, and fault isolation operations.

In embodiments, each central chiplet 720, 721, and 722 functions as an orchestrator for a respective processing lane composed of associated chiplets, including sensor data input chiplets 710, autonomous drive chiplets 731, 731b, 731c, autonomous drive chiplets 732, 732b, 732c, machine learning accelerators 740, 740b, 740c, 741, 741b, 741c, general compute chiplets 745, 745b, 745c, and HBM-RAM or DDR memory components 755, 756, 755b, 756b, 755c, 756c, 760, 760b, and 760c.

In some embodiments, the DDR on-package memory components 760, 760b, and 760c provide high-speed local memory storage for corresponding compute lanes and support execution of autonomous workloads, inference operations, mailbox synchronization, and temporary storage of execution state information. The flash memory in memory space 751 may provide persistent storage for firmware, degraded execution schemes, semaphore graphs, scheduling information, mailbox configurations, recovery configurations, or other state persistence information associated with operation of the mSoC architecture.

Each central chiplet includes a dedicated mailbox module 750, 750b, 750c, forming a distributed mailbox grid across the mSoC. These mailboxes allow asynchronous communication and state reporting between chiplets and across processing lanes. The voting system is implemented by having each central chiplet cross-check the outputs and internal state transitions of its peer lanes via these mailbox structures. Tasks and state metadata written into shared memories 730, 730b, and 730c are mirrored and analyzed in parallel by the neighboring central chiplets, enabling majority voting, outlier detection, and temporal execution validation. In some embodiments, the autonomous drive chiplets 732, 732b, and 732c provide additional redundant autonomous processing paths configured to independently execute perception, planning, navigation, or control workloads associated with corresponding execution lanes.

This intra-package voting approach allows for N-modular redundancy (NMR) where N is the number of active compute lanes (e.g., 3 in this case), enabling 2-out-of-3 majority voting to suppress transient faults or divergent results from individual chiplets. The voting mechanism is further supported by redundant interconnects (711a-711t and 799), ensuring that communication between the chiplets and shared memory modules remains fault-tolerant. An additional interconnect, numbered 799, connects central chiplets 720 and 722 directly, bypassing chiplet 721. This interconnect is a double redundant link interconnect, specifically designed to maintain high safety levels even in the event of a failure in chiplet 721, ensuring that critical voting and coordination can proceed between 720 and 722 without interruption. In some embodiments, machine learning accelerator chiplets 740, 740b, and 740c execute distributed machine learning inference operations and participate in cross-chiplet voting and validation operations across multiple compute lanes.

In certain implementations, the distributed voting mechanism supports heterogeneous voting operations across heterogeneous chiplets implementing different processing architectures, instruction sets, neural network models, inference engines, or execution strategies. Heterogeneous voting may improve fault detection capability by identifying systematic computational errors or divergent outputs generated by a particular architecture or computational model.

This architecture is especially beneficial for high-integrity applications such as automotive ASIL-D and aviation DO-254 DAL-A/B, as it ensures that critical functions (e.g., perception, trajectory planning, ML inference) are independently validated by at least two redundant paths within the same substrate. Furthermore, diversity in chiplet designs can be introduced, e.g., different ML engines (740 vs. 740b vs. 740c) or independent autonomous drive modules (731, 731b, 731c, 732, 732b, 732c), enabling heterogeneous voting across implementations to catch systemic or logic design flaws. In some implementations, the DDR on-package memory components 760, 760b, and 760c support localized execution buffering and reduce latency associated with cross-chiplet synchronization and voting operations.

The configuration can be extended to support more than three redundant systems within a single mSoC substrate. The architecture supports expansion to N redundant lanes, each composed of a central chiplet and associated processing chiplets. As the number of lanes increases, the voting system scales to support N-out-of-M majority logic, with configurable fault thresholds and adaptive weightings. Each additional central chiplet adds to the robustness of the distributed mailbox network, facilitating more granular fault isolation, broader cross-verification, and extended failover scenarios. This scalability ensures that the architecture can address safety requirements ranging from ASIL-B/C applications to ASIL-D and DAL-A/B/C for aviation, where redundancy beyond triple modularity may be required. The system can thus accommodate evolving regulatory demands and operational risk profiles by enabling deployment of four or more mirrored execution lanes within a single substrate or across interconnected mSoCs.

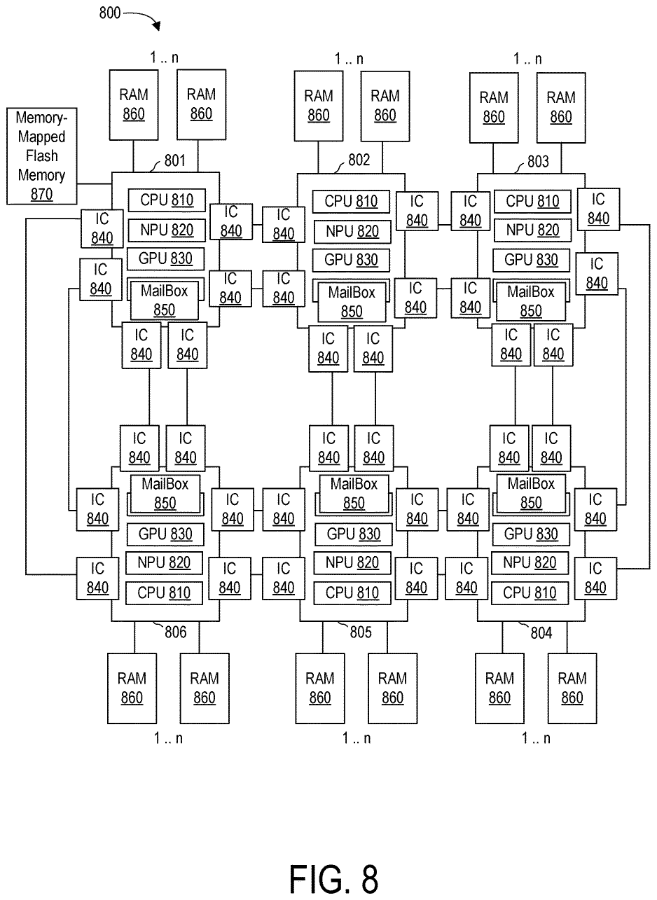

Referring to FIG. 8, FIG. 8 illustrates an exemplary multiple System-on-Chip (mSoC) architecture 800 implementing a distributed voting and mailbox communication system across multiple SoCs 801, 802, 803, 804, 805, and 806. In some embodiments, the mSoC architecture 800 includes multiple interconnected SoCs arranged to provide distributed redundancy, cross-SoC synchronization, voting operations, workload distribution, and fail-operational execution for safety-critical applications.

Each SoC 801-806 may include one or more computational components, such as one or more central processing units (CPUs) 810, one or more neural processing units (NPUs) 820, one or more graphics processing units (GPUs) 830, and one or more mailbox subsystems 850. In some embodiments, the mailbox subsystems are configured to collect execution data, intermediate computational results, status information, synchronization information, workload information, or fault information from one or more computational components within the corresponding SoC.

In certain implementations, each SoC 801-806 further includes one or more interconnects (ICs) 840 configured to facilitate communication between computational components within a corresponding SoC and communication between multiple SoCs. The ICs 840 may support distributed synchronization, cross-SoC communication, workload redistribution, fault reporting, failover signaling, and distributed voting operations between computational components and mailbox subsystems 850.

As illustrated in FIG. 8, each SoC 801-806 may further be coupled to one or more memory devices, such as random-access memory (RAM) devices 860 and memory-mapped flash memory 870. In some embodiments, the RAM devices 860 store execution data, intermediate computational results, task scheduling information, synchronization information, and state information associated with execution of one or more tasks by the corresponding SoC. The memory mapped flash memory 870 may store executable instructions, configuration information, neural network parameters, diagnostic information, voting configuration data, workload redistribution data, or recovery information associated with operation of the mSoC architecture 800.

In some embodiments, mailbox subsystems 850 distributed across multiple SoCs 801-806 are interconnected through the ICs 840 to form a distributed voting and arbitration network. The distributed voting and arbitration network may support majority voting, consensus generation, validation of computational outputs, distributed fault detection, workload synchronization, and cross-SoC arbitration across redundant processing paths. In certain implementations, outputs or execution results generated by CPUs 810, NPUs 820, GPUs 830, or other computational components are transmitted to corresponding mailbox subsystems 850 for validation and voting operations.

In certain embodiments, the mSoC architecture 800 supports N-modular redundancy configurations in which multiple SoCs execute redundant or partially redundant workloads. The mailbox subsystems 850 and ICs 840 collectively detect discrepancies between execution outputs generated by different SoCs and initiate corrective actions, including workload redistribution, degraded execution operation, computational component isolation, or failover execution by another SoC. In some implementations, the distributed voting architecture enables synchronized and fault-tolerant execution of autonomous system tasks, avionics tasks, robotics tasks, vehicle control tasks, or other safety-critical operations.

In some embodiments, one or more SoCs 801-806 may operate in a primary execution mode while one or more additional SoCs operate in a monitoring, backup, or low-power standby mode. The mailbox subsystems 850 may continuously exchange state information and execution information between SoCs to support real-time monitoring and rapid activation of backup computational components upon detection of a trigger condition, fault condition, execution mismatch, or voting discrepancy.

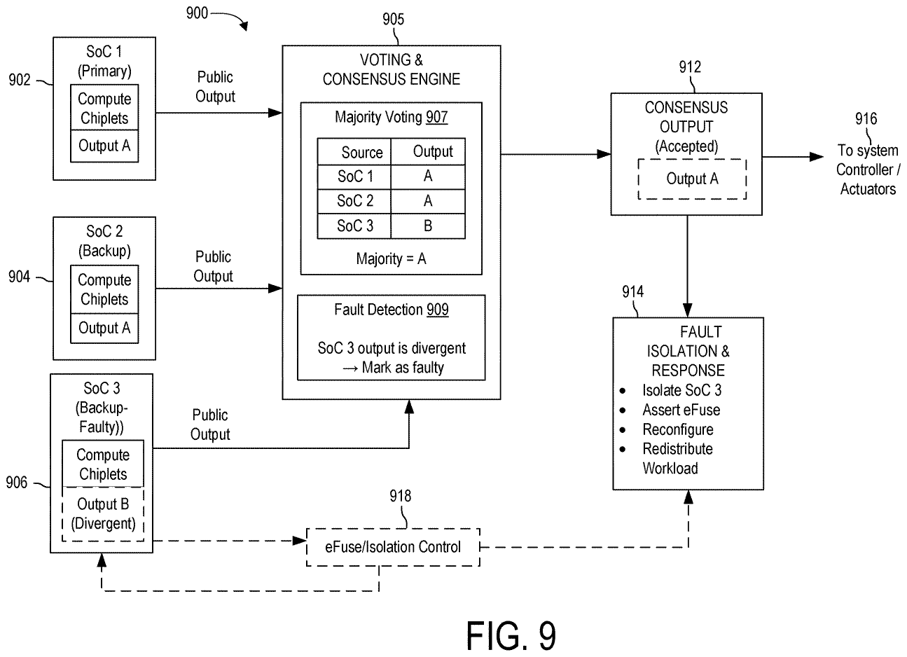

Referring to FIG. 9, FIG. 9 is a block diagram illustrating an exemplary voting-based fault detection and isolation architecture 900 in multiple System-on-Chip (SoC) devices, according to the embodiments of disclosed subject matter. FIG. 9 depicts the voting-based fault detection and isolation architecture 900 implemented across multiple System-on-Chip (SoC) devices configured to provide distributed redundancy, consensus-based execution validation, fail-operational behavior, and fault-tolerant operation for safety-critical applications. In some embodiments, the architecture 900 includes a first SoC 902, a second SoC 904, and a third SoC 906 configured to execute redundant or partially redundant computational tasks and participate in distributed voting operations.

In some embodiments, the first SoC 902 operates in a primary execution role and includes one or more compute chiplets configured to execute one or more tasks associated with autonomous system operation, inference processing, control operations, or other safety-critical workloads. The first SoC 902 generates a first output, illustrated as Output A, and transmits the output as a published output to a voting and consensus engine 905. Similarly, the second SoC 904 may operate in a backup, monitoring, or redundant execution role and may generate a corresponding output, illustrated as Output A, for validation through the voting and consensus engine 905.

In certain embodiments, the third SoC 906 may also participate in execution of the corresponding workloads and voting operations. As illustrated in FIG. 9, the third SoC 906 may generate an output illustrated as Output B, which differs from the outputs generated by the first SoC 902 and the second SoC 904. In some implementations, the differing output may result from a transient fault, permanent hardware fault, execution mismatch, synchronization failure, memory corruption event, interconnect fault, degraded chiplet operation, or machine learning inference discrepancy associated with one or more computational components of the third SoC 906.

In some embodiments, outputs generated by the first SoC 902, the second SoC 904, and the third SoC 906 are transmitted to the voting and consensus engine 905. The voting and consensus engine 905 may implement one or more voting operations including majority voting 907, ranked voting, weighted confidence-based voting, or other consensus determination operations. As illustrated in FIG. 9, the majority voting 907 operation compares outputs generated by corresponding SoCs and determines a consensus output based on agreement across redundant processing paths. In the illustrated example, outputs generated by SoC 1 and SoC 2 correspond to Output A, while the output generated by SoC 3 corresponds to Output B. Accordingly, the majority voting operation determines that the consensus output corresponds to Output A.

In certain embodiments, the voting and consensus engine 905 further performs fault detection operations 909 configured to identify divergent computational outputs, execution mismatches, timing inconsistencies, synchronization failures, or anomalous behavior associated with one or more SoCs or computational components. As illustrated in FIG. 9, the fault detection operations 909 determine that the output generated by the third SoC 906 diverges from the consensus output and marks the third SoC 906 as faulty. In some implementations, the voting and consensus engine 905 may additionally analyze timing information, execution confidence values, intermediate computational results, synchronization data, or mailbox status information associated with corresponding SoCs to identify fault conditions.

In some embodiments, the voting and consensus engine 905 generates a consensus output 912 corresponding to the accepted execution result determined through the voting operations. The consensus output 912 may correspond to a validated computational result that is transmitted to one or more system controllers, actuator systems, autonomous control systems, robotics systems, vehicle control systems, or flight control systems 916. In certain implementations, the consensus output 912 enables continued operation of the computing system despite one or more divergent outputs or degraded computational components within the architecture 900.

In certain embodiments, the architecture 900 further includes a fault isolation and response subsystem 914 configured to perform corrective actions in response to detection of a fault condition. The fault isolation and response subsystem 914 may isolate the third SoC 906, assert one or more electrical fuses (eFuses), reconfigure execution scheduling, redistribute workloads across remaining operational SoCs, initiate degraded execution operation, modify power states of computational components, or trigger recovery procedures associated with faulty computational components. In some implementations, the fault isolation and response subsystem 914 enables continued fail-operational execution while preventing fault propagation across the mSoC architecture.

As further illustrated in FIG. 9, the architecture 900 may include an eFuse or isolation control subsystem 918 coupled to the third SoC 906 and the fault isolation and response subsystem 914. In some embodiments, the eFuse or isolation control subsystem 918 selectively disconnects power rails, interconnect paths, communication interfaces, or computational components associated with a faulty SoC or chiplet. The eFuse or isolation control subsystem 918 may further support electrical isolation, fault containment, and protection against cascading electrical anomalies or fault propagation between SoCs and distributed compute domains.

In some embodiments, the voting and consensus operations illustrated in FIG. 9 are implemented using distributed mailbox subsystems located within coordination chiplets associated with corresponding SoCs. The mailbox subsystems may collect execution data, intermediate computational results, synchronization information, status information, fault information, or voting-related information from one or more chiplets distributed across the SoCs. In certain implementations, the distributed mailbox architecture enables real-time validation, synchronization, consensus generation, and coordinated fault isolation across redundant processing paths.

In certain implementations, the architecture 900 supports N-modular redundancy configurations in which three or more SoCs execute redundant or partially redundant workloads and participate in distributed voting operations. The voting and consensus engine 905 may support majority voting, weighted voting, ranked voting, confidence-based arbitration, or hybrid consensus operations to validate outputs generated across homogeneous or heterogeneous compute elements. The architecture 900 may further support compliance with automotive safety integrity level (ASIL) and Design Assurance Level (DAL) requirements for autonomous systems, avionics systems, robotics systems, and other safety-critical applications.

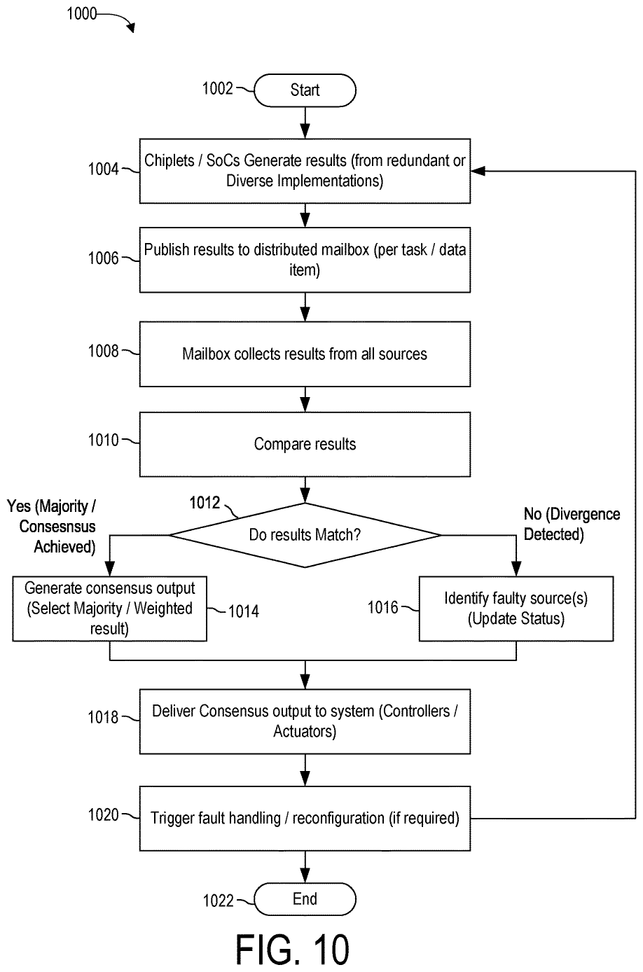

Referring to FIG. 10, FIG. 10 is a flow diagram illustrating an exemplary mailbox-based distributed voting and fault-handling process implemented in a multiple System-on-Chip (mSoC) architecture.

FIG. 10 illustrates an exemplary process 1000 for performing distributed mailbox-based voting, consensus determination, fault detection, and fault-handling operations across multiple System-on-Chip (SoC) devices and distributed computational components. In some embodiments, the process 1000 is implemented using distributed mailbox subsystems, coordination chiplets, voting and consensus engines, and redundant processing paths distributed across multiple SoCs within an mSoC architecture.

In some embodiments, FIG. 10 illustrates a distributed voting and consensus determination process performed across multiple SoCs and corresponding chiplets executing workloads across redundant processing paths. The operations illustrated in FIG. 10 may be performed by distributed mailbox subsystems and a voting and consensus engine configured to validate execution results, identify divergent outputs, isolate faulty chiplets, and maintain execution in a degraded operational mode.

At block 1002, the process 1000 begins. In some embodiments, the process 1000 is initiated during execution of one or more safety-critical workloads associated with autonomous systems, robotics systems, avionics systems, vehicle control systems, flight control systems, or other distributed computing environments requiring fault-tolerant and fail-operational execution.

At block 1004, one or more chiplets or SoCs generate execution results corresponding to one or more tasks. In some implementations, the execution results are generated by redundant or diverse computational implementations distributed across multiple SoCs and chiplets. The computational components may include sensor processing chiplets, inference or machine learning (ML) chiplets, planning or control chiplets, general compute chiplets, or other computational components configured to perform corresponding portions of a workload. In certain implementations, multiple SoCs execute redundant workloads in parallel to enable distributed validation of execution outputs.

At block 1006, the generated execution results are published to one or more distributed mailbox subsystems. In some embodiments, each mailbox subsystem corresponds to a particular task, computational domain, chiplet group, data item, or execution pipeline. The mailbox subsystems may collect execution outputs, intermediate computational results, synchronization information, timing information, status information, confidence values, workload information, or diagnostic information associated with execution of the corresponding tasks.

At block 1008, the distributed mailbox subsystems collect results from multiple computational sources. In some implementations, the mailbox subsystems aggregate execution outputs generated by multiple SoCs, redundant chiplets, or heterogeneous compute elements participating in execution of corresponding workloads. The mailbox subsystems may further exchange synchronization information and status information between distributed compute domains to support coordinated voting operations.

At block 1010, one or more voting operations compare the collected execution results. In some embodiments, the comparison operations are performed by a distributed voting mechanism or a voting and consensus engine configured to validate outputs generated across redundant processing paths. The voting operations may include majority voting, weighted confidence-based voting, ranked voting, consensus determination operations, or hybrid arbitration operations. In certain implementations, the voting mechanism analyzes execution outputs, timing information, synchronization information, confidence metrics, intermediate computational data, or fault-related information associated with the corresponding computational sources.

At decision block 1012, the process 1000 determines whether the collected execution results match or satisfy a voting threshold or consensus condition. In some embodiments, the determination corresponds to whether a majority agreement, weighted confidence threshold, synchronization threshold, or other consensus requirement is achieved across the collected outputs.

If the collected execution results satisfy the voting or consensus condition, the process 1000 proceeds to block 1014. At block 1014, a consensus output is generated based on the validated execution results. In some implementations, the consensus output corresponds to a majority-selected output, weighted result, consensus result, or otherwise validated execution result determined through the distributed voting operations. The consensus output may represent a validated command, control signal, inference result, trajectory output, object classification result, planning result, or other computational output associated with operation of the computing system.

If the collected execution results do not satisfy the voting or consensus condition, the process 1000 proceeds to block 1016. At block 1016, one or more faulty sources are identified and corresponding status information may be updated. In some embodiments, the faulty sources correspond to one or more SoCs, chiplets, communication interfaces, memory components, or computational domains generating divergent outputs, inconsistent timing behavior, synchronization failures, corrupted data, or anomalous execution results. In certain implementations, the process 1000 marks one or more computational sources as degraded, faulty, isolated, or unavailable for subsequent execution operations.

At block 1018, the consensus output or validated execution result is delivered to one or more system controllers, actuator systems, autonomous control systems, robotics systems, vehicle control systems, flight control systems, or other downstream computational components. In some embodiments, delivery of the validated execution result enables continued fail-operational execution of safety-critical workloads despite detection of one or more faults or divergent execution results within the distributed computing system.

At block 1020, the process 1000 triggers one or more fault-handling, recovery, reconfiguration, or workload redistribution operations. In some implementations, the fault-handling operations include activating backup SoCs, redistributing workloads across operational chiplets, transitioning computational components between active and low-power states, asserting electrical fuse (eFuse) circuitry, isolating faulty chiplets or SoCs, initiating degraded execution operation, updating voting configurations, or reconfiguring workload scheduling across the distributed compute architecture. In certain implementations, the fault-handling operations enable continued synchronized execution and fault-tolerant operation across multiple SoCs and distributed compute domains.

In some embodiments, after completion of the fault-handling or reconfiguration operations, the process 1000 may return to block 1004 to continue generation, validation, and synchronization of execution results across redundant processing paths. The process 1000 may therefore continuously monitor execution outputs and dynamically adapt operation of the mSoC architecture in response to changing fault conditions, workload conditions, synchronization conditions, or runtime execution states.

At block 1022, the process 1000 ends. In some embodiments, the process 1000 may execute continuously or iteratively during operation of the computing system to support distributed voting, consensus validation, fault isolation, workload synchronization, and fail-operational execution in safety-critical computing environments.

In some embodiments, one or more functional chiplets publish execution results and corresponding state information into distributed mailbox subsystems while executing workloads across redundant processing paths. A voting and consensus engine may collect the execution results and corresponding state information from the mailbox subsystems, compare outputs generated across the redundant processing paths, determine a consensus result based on a voting operation, identify a chiplet associated with a divergent output, and isolate the identified chiplet while redistributing workloads across remaining operational processing paths to maintain execution in a degraded operational mode.

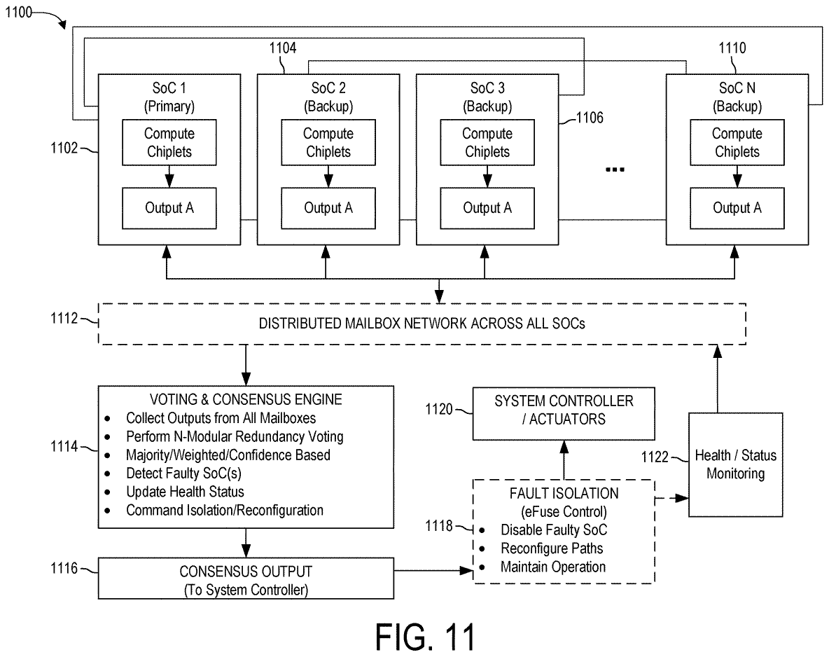

Referring to FIG. 11, FIG. 11 is a block diagram illustrating an exemplary N-modular redundancy architecture implementing distributed mailbox-based voting, consensus validation, and fault isolation across multiple System-on-Chip (SoC) devices.

FIG. 11 illustrates an exemplary N-modular redundancy architecture 1100 configured to provide distributed fault tolerance, consensus-based execution validation, fail-operational behavior, and high-reliability operation across multiple System-on-Chip (SoC) devices. In some embodiments, the architecture 1100 includes a first SoC 1102, a second SoC 1104, a third SoC 1106, and an Nth SoC 1110 configured to execute redundant or partially redundant workloads and participate in distributed voting operations through a distributed mailbox network 1112.

In some embodiments, the first SoC 1102 operates in a primary execution role while the second SoC 1104, the third SoC 1106, and the Nth SoC 1110 operate in backup, monitoring, redundant execution, or standby roles. Each SoC may include one or more compute chiplets configured to execute one or more tasks associated with autonomous systems, robotics systems, avionics systems, vehicle control systems, flight control systems, machine learning inference systems, or other safety-critical workloads. In certain implementations, the SoCs execute corresponding workloads in parallel to support distributed validation of execution outputs.

As illustrated in FIG. 11, the first SoC 1102, the second SoC 1104, the third SoC 1106, and the Nth SoC 1110 may each generate execution outputs illustrated as Output A. In some embodiments, the outputs correspond to inference outputs, planning outputs, trajectory generation outputs, control outputs, classification outputs, sensor processing outputs, or other execution results associated with corresponding computational workloads. Although FIG. 11 illustrates matching outputs, one or more SoCs may alternatively generate divergent outputs due to transient faults, permanent faults, timing inconsistencies, synchronization failures, memory corruption events, degraded chiplet operation, interconnect failures, or computational anomalies.

In some embodiments, outputs and execution information generated by the SoCs are transmitted to the distributed mailbox network 1112. The distributed mailbox network 1112 may comprise multiple mailbox subsystems distributed across corresponding SoCs and chiplets. In certain implementations, the mailbox subsystems collect execution data, synchronization information, timing information, intermediate computational results, status information, workload information, diagnostic information, confidence values, or fault-related information associated with execution of corresponding tasks by the SoCs.

In certain embodiments, the distributed mailbox network 1112 facilitates cross-SoC communication, distributed synchronization, inter-chiplet communication, failover signaling, workload coordination, and voting-related information exchange across multiple SoCs and distributed compute domains. In some implementations, the SoCs may reside on a same substrate, on different substrates, within a same package, or across multiple packages while participating in distributed voting operations through the distributed mailbox network 1112.

In some embodiments, outputs and execution information collected by the distributed mailbox network 1112 are provided to a voting and consensus engine 1114. The voting and consensus engine 1114 may collect outputs from all mailbox subsystems and perform N-modular redundancy voting across multiple SoCs. In certain implementations, the voting and consensus engine 1114 performs majority voting, weighted confidence-based voting, ranked voting, consensus arbitration, or hybrid voting operations to validate execution outputs generated across redundant processing paths.

In some embodiments, the voting and consensus engine 1114 further detects faulty SoCs, divergent computational outputs, execution mismatches, synchronization failures, timing inconsistencies, degraded chiplet behavior, or anomalous execution conditions associated with one or more SoCs or computational components. The voting and consensus engine 1114 may further update health and status information associated with corresponding SoCs and issue commands associated with isolation, reconfiguration, workload redistribution, degraded execution operation, or failover activation.

In certain implementations, the voting and consensus engine 1114 generates a consensus output 1116 corresponding to a validated computational result determined through distributed voting operations. The consensus output 1116 may correspond to a majority-selected result, weighted confidence-based result, ranked consensus result, or otherwise validated execution output. In some embodiments, the consensus output 1116 is transmitted to one or more system controllers or actuator systems 1120 configured to control autonomous systems, robotics systems, vehicle systems, avionics systems, industrial systems, or other safety-critical systems.

In some embodiments, the architecture 1100 further includes a fault isolation subsystem 1118 configured to isolate faulty SoCs or computational components in response to detection of divergent outputs or fault conditions. The fault isolation subsystem 1118 may disable a faulty SoC, reconfigure execution scheduling, redistribute workloads across operational SoCs or chiplets, transition computational components between active and low-power states, or maintain continued operation through degraded execution modes. In certain implementations, the fault isolation subsystem 1118 supports fail-operational behavior by maintaining execution of safety-critical workloads despite isolation or removal of one or more faulty SoCs.

In some embodiments, health and status monitoring circuitry 1122 monitors operational status, synchronization information, workload execution, timing behavior, diagnostic information, power conditions, thermal conditions, voting status information, or fault conditions associated with the SoCs and distributed compute domains. The health and status monitoring circuitry 1122 may communicate with the fault isolation subsystem 1118, the distributed mailbox network 1112, the voting and consensus engine 1114, or the system controllers and actuator systems 1120 to coordinate fault detection, workload redistribution, system recovery, or reconfiguration operations.

In certain embodiments, the N-modular redundancy architecture 1100 enables distributed consensus generation, synchronized execution, fault containment, and fail-operational execution across homogeneous and heterogeneous compute elements distributed across multiple SoCs. The architecture 1100 may support dynamic workload reassignment, degraded execution operation, distributed fault isolation, and real-time validation of computational outputs while maintaining compliance with automotive safety integrity level (ASIL) and Design Assurance Level (DAL) requirements for safety-critical computing environments.

A computing system includes a first system on a chip (SoC) comprising a first memory, the first SoC configured to publish, in the first memory, state information corresponding to a set of tasks being performed by the first SoC, the first SoC comprising a first plurality of computational components; and a second SoC comprising a second memory and a second plurality of computational components, the second SoC having memory access to the first memory to dynamically read the state information published by the first SoC, wherein the second SoC is configured to maintain a subset of the second plurality of computational components in a low power state. Each SoC comprises a distributed voting mechanism with mailbox subsystems located within a coordination chiplet, wherein outputs from one or more functional chiplets are submitted to the mailbox subsystems for majority voting. When the second SoC detects a trigger while reading the state information published in the first memory, the second SoC is configured to activate the subset of the second plurality of computational components to perform the set of tasks.

The set of tasks may comprise autonomous tasks, the autonomous tasks comprising sensor data perception and inference tasks for autonomously operating a system along a trajectory. The trigger may correspond to the first SoC experiencing a fault or a failure, the fault or the failure corresponding to the first SoC overheating, a power surge, or an error in the first SoC. Each time the computing system is rebooted, the first SoC and the second SoC may switch roles with respect to performing the set of tasks and placing a subset of the corresponding plurality of computational components in the low power state and dynamically reading published state information from the first SoC or second SoC. The first SoC may be powered by a first power source of a system, and the second SoC may be powered by a second power source of the system, wherein the first power source comprises a battery pack used for propulsion of the system, and wherein the second power source comprises an auxiliary power source of the system. The first SoC and the second SoC may be electrically coupled to each other via an interconnect having at least one electrical safety switch to protect the computing system from power surges from either the first SoC or the second SoC. The first SoC may dynamically read the second memory of the second SoC to determine whether the second SoC is ready to perform the set of tasks being performed by the first SoC. The first SoC and the second SoC may be configured to dynamically read the state information and perform the set of tasks, providing redundancy to facilitate a safety and integrity certification for the computing system, wherein the integrity certification comprises an automotive safety integrity level (ASIL) rating for autonomous drive computing.

The first plurality of computational components and the second plurality of computational components may comprise chiplets of each of the first SoC and the second SoC, wherein the subset of the second plurality of computational components in a low power state comprises one or more of general compute chiplets, autonomous drive chiplets, machine learning (ML) accelerator chiplets, sensor input chiplets, and high bandwidth memory chiplets. Each of the first plurality of computational components and the second plurality of computational components may include a functional safety (FuSa) CPU that publishes state information of the first SoC and the second SoC to a FuSa component of the first memory and the second memory respectively, wherein the first SoC and the second SoC are configured to maintain the FuSa CPU outside the low power state. When the second SoC performs the set of tasks of the first SoC, the first SoC may reset or reboot the first plurality of computational components. Each chiplet of the first plurality of computational components and the second plurality of computational components may include a FuSa memory segment configured to store local state information, wherein the computing system is configured to continue operating in a degraded mode when one or more chiplets become non-functional and the respective SoC is configured to perform the set of tasks with fewer chiplets. Each SoC may comprise hardware circuitry configured to control and monitor internal voltage regulation and power distribution, wherein the SoC is configured to measure current and voltage delivered to each chiplet and isolate and power off individual chiplets by triggering an electrical fuse (eFuse) through a dual-bit functional safety (FuSa) control line for safe disconnection under fault conditions.

Each SoC may comprise a scheduler configured to adapt to a degradation event by recalculating the set of tasks to be performed based on availability of functional chiplets, for a continued operation at a reduced processing capacity while maintaining functional safety guarantees. The first SoC may be configured to perform individual health diagnostics of each chiplet, detect error conditions published to the corresponding mailbox, and in response to a fault in a chiplet, execute a degradation path comprising configuring an eFuse control mechanism to selectively disable one or more power rails associated with a faulty chiplet and loading a preconfigured semaphore graph that redistributes a workload of the faulty chiplet across remaining operational chiplets. Each of the first SoC and the second SoC may be configured with per-chiplet diagnostic logic, eFuse control circuitry, and preconfigured semaphore graphs, wherein either SoC, when operating in a primary role, is configured to isolate a degraded chiplet and dynamically reconfigure workload across remaining operational chiplets to maintain functional safety and system availability in a degraded execution mode, wherein the first SoC and the second SoC are configured to achieve an automotive safety integrity level (ASIL-D) rating through per-chiplet eFuse protection circuitry configured to isolate chiplets in response to electrical anomalies. Each of the first SoC and the second SoC may comprise a subsystem configured to continuously monitor operational status and workload performance of a corresponding paired SoC, wherein, in response to detection of a discrepancy based on mailbox analysis indicating mismatched scheduling or unexpected runtime behavior, the monitoring SoC is configured to initiate a remote degradation process on the paired SoC by triggering a diagnostic degradation mode, loading a degraded execution scheme, and storing said scheme in a predefined safe memory area of the paired SoC for execution under functional safety constraints.

The system may comprise three or more SoCs on a same substrate or die package, each equipped with mailbox modules and coordination chiplets for N-modular redundancy voting where a mailbox network forms a distributed decision mechanism that isolates divergent outputs and maintains consensus under ASIL-D and DO-254 conditions, wherein the distributed voting mechanism allows for detection and containment of transient and permanent faults across diverse chiplet implementations, for providing mixed redundancy using both homogeneous and heterogeneous compute elements within or across multiple SoCs. Each SoC may include one or more mailbox modules distributed across corresponding chiplets, each mailbox configured to collect local execution data, status signals, or intermediate results from associated chiplets, wherein the one or more mailbox modules are interconnected to form a cross-chiplet communication fabric for inter-chiplet voting, error reporting, workload scheduling feedback, and failover signaling in compliance with functional safety protocols, and wherein each mailbox subsystem is further configured to schedule workloads across chiplets, manage per-chiplet power states, support out-of-order task scheduling, and enable simultaneous multi-threading (SMT) execution across eligible compute chiplets. The computing system may be implemented within a flight control unit, and a voting logic may be configured to provide fail-operational behavior under Design Assurance Level A (DAL-A) conditions.

A computing system includes a plurality of system-on-chip (SoC) devices, each SoC comprising a plurality of computational components implemented as chiplets, and a plurality of mailbox subsystems distributed across the plurality of SoC devices. One or more functional chiplets of the plurality of computational components are configured to publish execution results and state information into corresponding mailbox subsystems. The computing system further includes a voting and consensus engine configured to collect execution results and corresponding state information from the mailbox subsystems, compare outputs generated across redundant processing paths, determine a consensus result based on a voting operation, identify a chiplet associated with a divergent output based on the comparison, and isolate the identified chiplet and redistribute one or more workloads across remaining operational processing paths to maintain execution in a degraded operational mode. The computing system may comprise three or more SoC devices implemented within a same substrate or die package, each SoC device comprising a corresponding mailbox subsystem and a coordination chiplet configured to perform N-modular redundancy voting through the mailbox subsystems to isolate divergent outputs and maintain consensus across homogeneous or heterogeneous chiplets. The voting and consensus engine may further be configured to perform heterogeneous voting operations across heterogeneous chiplets and, in response to identifying the chiplet associated with the divergent output, initiate fault isolation through an eFuse circuitry while maintaining consensus across remaining operational processing paths.

A computer-implemented method includes generating, by a plurality of system-on-chip (SoC) devices comprising a plurality of computational components implemented as chiplets, execution results and state information associated with workloads executed across redundant processing paths. One or more functional chiplets of the plurality of computational components publish the execution results and the state information into corresponding mailbox subsystems distributed across the plurality of SoC devices. A voting and consensus engine collects the execution results and the state information from the mailbox subsystems, compares outputs generated across the redundant processing paths, and determines a consensus result based on a voting operation. The voting and consensus engine further identifies a chiplet associated with a divergent output based on the comparison and isolates the identified chiplet while redistributing one or more workloads across remaining operational processing paths to maintain execution in a degraded operational mode.

Many variations may be made to the embodiments described herein. All variations, including combinations of embodiments, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A computing system comprising:
a first system on a chip (SoC) comprising a first memory, the first SoC configured to publish, in the first memory, state information corresponding to a set of tasks being performed by the first SoC, the first SoC comprising a first plurality of computational components; and
a second SoC comprising a second memory and a second plurality of computational components, the second SoC having memory access to the first memory to dynamically read the state information published by the first SoC, wherein the second SoC is configured to maintain a subset of the second plurality of computational components in a low power state;
wherein each SoC comprises a distributed voting mechanism with mailbox subsystems located within a coordination chiplet, and wherein outputs from one or more functional chiplets are submitted to the mailbox subsystems for majority voting;
wherein, when the second SoC detects a trigger while reading the state information published in the first memory, the second SoC is configured to activate the subset of the second plurality of computational components to perform the set of tasks.

2. The computing system of claim 1, wherein the set of tasks comprises autonomous tasks, the autonomous tasks comprising sensor data perception and inference tasks for autonomously operating a system along a trajectory.

3. The computing system of claim 1, wherein the trigger corresponds to the first SoC experiencing a fault or a failure, the fault or the failure corresponding to the first SoC overheating, a power surge, or an error in the first SoC.

4. The computing system of claim 1, wherein the first SoC dynamically reads the second memory of the second SoC to determine whether the second SoC is ready to perform the set of tasks being performed by the first SoC; and
wherein each time the computing system is rebooted, the first SoC and the second SoC are configured to switch roles with respect to:
performing the set of tasks; and
placing a subset of the corresponding plurality of computational components in the low power state and dynamically reading published state information from the first SoC or second SoC.

5. The computing system of claim 1, wherein the first SoC is powered by a first power source of a system, and the second SoC is powered by a second power source of the system;
wherein the first power source comprises a battery pack used for propulsion of the system, and wherein the second power source comprises an auxiliary power source of the system;
wherein the first SoC and the second SoC are electrically coupled to each other via an interconnect having at least one electrical safety switch to protect the computing system from power surges from either the first SoC or the second SoC.

6. The computing system of claim 1, wherein the first SoC and the second SoC are configured to dynamically read the state information and perform the set of tasks, providing redundancy to facilitate a safety and integrity certification for the computing system;
wherein the integrity certification comprises an automotive safety integrity level (ASIL) rating for autonomous drive computing.

7. The computing system of claim 1, wherein the first plurality of computational components and the second plurality of computational components comprise chiplets of each of the first SoC and the second SoC;
wherein the subset of the second plurality of computational components in a low power state comprises one or more of general compute chiplets, autonomous drive chiplets, machine learning (ML) accelerator chiplets, sensor input chiplets, and high bandwidth memory chiplets.

8. The computing system of claim 7, wherein each of the first plurality of computational components and the second plurality of computational components include a functional safety (FuSa) CPU that publishes state information of the first SoC and the second SoC to a FuSa component of the first memory and the second memory respectively;
wherein the first SoC and the second SoC are configured to maintain the FuSa CPU outside the low power state.

9. The computing system of claim 1, wherein when the second SoC performs the set of tasks of the first SoC, the first SoC resets or reboots the first plurality of computational components;
wherein each chiplet of the first plurality of computational components and the second plurality of computational components includes a FuSa memory segment configured to store local state information;
wherein the computing system is configured to continue operating in a degraded mode when one or more chiplets become non-functional and the respective SoC is configured to perform the set of tasks with fewer chiplets.

10. The computing system of claim 1, wherein each SoC comprises hardware circuitry configured to control and monitor internal voltage regulation and power distribution, wherein the SoC is configured to measure current and voltage delivered to each chiplet and isolate and power off individual chiplets by triggering an electrical fuse (eFuse) through a dual-bit functional safety (FuSa) control line for safe disconnection under fault conditions.

11. The computing system of claim 1, wherein each SoC comprises a scheduler configured to adapt to a degradation event by recalculating the set of tasks to be performed based on availability of functional chiplets, for a continued operation at a reduced processing capacity while maintaining functional safety guarantees.

12. The computing system of claim 1, wherein the first SoC is configured to:
perform individual health diagnostics of each chiplet;
detect error conditions published to the corresponding mailbox; and
in response to a fault in a chiplet, execute a degradation path comprising:
configuring an eFuse control mechanism to selectively disable one or more power rails associated with a faulty chiplet; and
loading a preconfigured semaphore graph that redistributes a workload of the faulty chiplet across remaining operational chiplets.

13. The computing system of claim 1, wherein each of the first SoC and the second SoC is configured with per-chiplet diagnostic logic, eFuse control circuitry, and preconfigured semaphore graphs,
wherein either SoC, when operating in a primary role, is configured to isolate a degraded chiplet and dynamically reconfigure workload across remaining operational chiplets to maintain functional safety and system availability in a degraded execution mode;
wherein the first SoC and the second SoC are configured to achieve an automotive safety integrity level (ASIL-D) rating through per-chiplet eFuse protection circuitry configured to isolate chiplets in response to electrical anomalies.

14. The computing system of claim 1, wherein each of the first SoC and the second SoC comprises a subsystem configured to continuously monitor operational status and workload performance of a corresponding paired SoC,
wherein, in response to detection of a discrepancy based on mailbox analysis indicating mismatched scheduling or unexpected runtime behavior, the monitoring SoC is configured to initiate a remote degradation process on the paired SoC by:
triggering a diagnostic degradation mode;
loading a degraded execution scheme; and
storing said scheme in a predefined safe memory area of the paired SoC for execution under functional safety constraints.

15. The computing system of claim 1, wherein each SoC includes one or more mailbox modules distributed across corresponding chiplets, each mailbox configured to collect local execution data, status signals, or intermediate results from associated chiplets;
wherein the one or more mailbox modules are interconnected to form a cross-chiplet communication fabric for inter-chiplet voting, error reporting, workload scheduling feedback, and failover signaling in compliance with functional safety protocols; and
wherein each mailbox subsystem is further configured to schedule workloads across chiplets, manage per-chiplet power states, support out-of-order task scheduling, and enable simultaneous multi-threading (SMT) execution across eligible compute chiplets.

16. The computing system of claim 1, wherein the computing system is implemented within a flight control unit, and a voting logic is configured to provide fail-operational behavior under Design Assurance Level A (DAL-A) conditions.

17. A computing system comprising:
a plurality of system-on-chip (SoC) devices, each SoC comprising a plurality of computational components implemented as chiplets;
a plurality of mailbox subsystems distributed across the plurality of SoC devices;
wherein one or more functional chiplets of the plurality of computational components are configured to publish execution results and state information into corresponding mailbox subsystems; and
a voting and consensus engine configured to:
collect execution results and corresponding state information from the mailbox subsystems;
compare outputs generated across redundant processing paths;
determine a consensus result based on a voting operation;
identify a chiplet associated with a divergent output based on the comparison; and
isolate the identified chiplet and redistribute one or more workloads across remaining operational processing paths to maintain execution in a degraded operational mode.

18. The computing system of claim 17, wherein the computing system comprises three or more SoC devices implemented within a same substrate or die package, each SoC device comprising a corresponding mailbox subsystem and a coordination chiplet configured to perform N-modular redundancy voting through the mailbox subsystems to isolate divergent outputs and maintain consensus across homogeneous or heterogeneous chiplets.

19. The computing system of claim 17, wherein the voting and consensus engine is configured to:
perform heterogeneous voting operations across heterogeneous chiplets; and
in response to identifying the chiplet associated with the divergent output, initiate fault isolation through an eFuse circuitry while maintaining consensus across remaining operational processing paths.

20. A computer-implemented method comprising:
generating, by a plurality of system-on-chip (SoC) devices comprising a plurality of computational components implemented as chiplets, execution results and state information associated with workloads executed across redundant processing paths;
publishing, by one or more functional chiplets of the plurality of computational components, the execution results and the state information into corresponding mailbox subsystems distributed across the plurality of SoC devices;
collecting, by a voting and consensus engine, the execution results and the state information from the mailbox subsystems;
comparing, by the voting and consensus engine, outputs generated across the redundant processing paths;
determining, by the voting and consensus engine, a consensus result based on a voting operation;
identifying, by the voting and consensus engine, a chiplet associated with a divergent output based on the comparison; and
isolating, by the voting and consensus engine, the identified chiplet and redistributing one or more workloads across remaining operational processing paths to maintain execution in a degraded operational mode.
